(19) United States
(12) Patent Application Publication
(10) Pub. No.: US 2005/0213798 A1
(43) Pub. Date: Sep. 29, 2005

(54) Apparatus, method and program for collating input image with reference image as well as computer-readable recording medium recording the image collating program

(75) Inventors: Yasufumi Itoh, Tenri-shi (JP); Manabu Yumoto, Nara-shi (JP); Manabu Onozaki, Nara-shi (JP)

Correspondence Address: BIRCH STEWART KOLASCH & BIRCH, PO BOX 747, FALLS CHURCH, VA, 22040-0747, US

(73) Assignee: Sharp Kabushiki Kaisha

(21) Appl. No.: 11/090,865

(22) Filed: Mar. 28, 2005

(30) Foreign Application Priority Data
Mar. 29, 2004 (JP) 2004-096461 (P)

(51) Int. Cl. G06K 9/00

(52) U.S. Cl. 382/124

(57) ABSTRACT

In an image collating apparatus, when images are input, a cumulative value of movement vectors obtained between input images is calculated, and fingerprint input and collating method (sensing method) are determined according to the cumulative value. According to a result of the determination, fingerprint data is obtained in either a sweep sensing method or an area sensing method. Calculation is performed to determine a similarity score between image data of the fingerprint obtained in one of the methods and a reference image data, and a result of the collation is provided. The result of the collation includes information relating to the employed collation method, and a target selected from a plurality of control targets is controlled according to the result of the collation.

This nonprovisional application is based on Japanese Patent Application No. 2004-096461 filed with the Japan Patent Office on Mar. 29, 2004, the entire contents of which are hereby incorporated by reference.

### BACKGROUND OF THE INVENTION

1. Field of the Invention

The present invention relates to an image collating apparatus, an image collating method, an image collating program and a computer-readable recording medium recording the image collating program. More specifically, the present invention relates to an image collating apparatus, an image collating method and an image collating program, which can selectively use a sweep sensing method and an area sensing method, as well as a computer-readable recording medium recording the image collating program.

2. Description of the Background Art

Conventional methods of collating fingerprint images can be classified broadly into image feature matching method and image-to-image matching method. In the former, image feature matching, images are not directly compared with each other but features in the images are extracted, and are compared with each other, as described in KOREDE WAKATTA BIOMETRICS (This Is Biometrics), edited by Japan Automatic Identification Systems Association, OHM sha, pp.42-44. When this method is applied to fingerprint image collation, minutiae (ridge characteristics of a fingerprint that occur at ridge bifurcations and ending, and few to several minutiae can be found in a fingerprint image) such as shown in FIGS. 15A and 15B serve as the image feature. According to this method, minutiae are extracted by image processing from images such as shown in FIGS. 16A to 16D; based on the positions, types and ridge information of the extracted minutiae, a similarity score is determined as the number of minutiae of which relative position and direction match among the images; the similarity score is incremented/decremented in accordance with match/mismatch in, for example, the number of ridges traversing the minutiae; and the similarity score thus obtained is compared with a predetermined threshold for collation and identification.

In the latter method, that is, in image-to-image matching, from images “α” and “β” to be collated with each other shown in FIGS. 17A and 17B, partial images “α1” and “β1”, that may correspond to the full area or partial area, are extracted; matching score between partial images “α1” and “β1” is calculated based on total sum of difference values, correlation coefficient, phase correlation method or group delay vector method, as the similarity score between images “α” and “β”; and the calculated similarity score is compared with a predetermined threshold for collation and identification.

Inventions utilizing the image-to-image matching method have been disclosed, for example, in Japanese Patent Laying-Open No. 63-211081 and Japanese Patent Laying-Open No. 63-078286. In the invention of Japanese Patent Laying-Open No. 63-211081, first, an object image is subjected to image-to-image matching, the object image is then divided into four small areas, and in each divided area, positions that attain maximum matching score in peripheral portions are found, and an average matching score is calculated therefrom, to obtain a corrected similarity score. This approach addresses distortion or deformation of fingerprint images that inherently occur at the time the fingerprints are collected. In the invention of Japanese Patent Laying-Open No. 63-078286, one fingerprint image is compared with a plurality of partial areas that include features of the one fingerprint image, while substantially maintaining positional relation among the plurality of partial areas, and total sum of matching scores of the fingerprint image with respective partial areas is calculated and provided as the similarity score.

These image-to-image matching method and image feature matching method, image collation is performed according the similarity score, which is based on the matching score exhibited between minutiae or between image data. However, the matching score may lower due to variations in condition during input of the image data even if the target image data is unchanged. Therefore, a high collation accuracy cannot be obtained stably without difficulty.

Generally speaking, the image-to-image matching method is more robust to noise and finger condition variations (dryness, sweat, abrasion and the like), while the image feature matching method enables higher speed of processing than the image-to-image matching as the amount of data to be compared is smaller. Even when the image is inclined, the image feature matching method can attempt the matching by determining relative positions and directions between minutiae.

For overcoming the problems of the image-to-image matching method and image feature matching method described above, Japanese Patent Laying-Open No. 2003-323618 has proposed the following image collating process. For each of a plurality of partial areas set in one of the images (see FIGS. 18A and 18B), the other image is searched to identify a maximum matching score position, i.e., a position of a partial image, which exhibits the maximum matching score. The maximum matching scores of these positions are compared with a predetermined threshold (see FIG. 18C) to calculate the similarity score achieved between the two images. FIGS. 18A and 18B show movement vectors V1, V2 . . . and Vn indicating position deviations between partial areas R1, R2, R3, . . . and Rn of the one image and partial areas M1, M2, M3, . . . and Mn of the other image.

As shown in FIGS. 19 and 20, the conventional input method for fingerprint images is classified basically into an area sensing method (FIG. 20) and a sweep sensing method (FIG. 19). For example, the sweep sensing method is disclosed in Japanese Patent Laying-Open No. H05-174133. According to the area sensing method,.a finger is placed on an area, and fingerprint information is input by performing sensing over a whole area at a time. According to the sweep sensing method in FIG. 19, sensing is performed by moving a finger in a direction of an arrow on a sensor. Japanese Patent Laying-Open No. 2003-323618 has disclosed a technique relating to the area sensing method. The area sensing method disclosed in Japanese Patent Laying-Open No. 2003-323618 requires a sensor having a larger area than the sweep sensing method for increasing an accuracy of fingerprint authentication. Further, the sensor such as a semiconductor sensor cannot achieve a high cost-to-area ratio because a material cost is high. Therefore, the sweep sensing method is advantageous for portable devices, which must have small footprints, and must be inexpensive. Although the sweep sensing method has a small footprint and is inexpensive, it requires a longer time for collation than the area sensing method. Japanese Patent Laying-Open No. H05-174133 has disclosed a sensor operable in both the sweep sensing method and the area sensing method.

In the prior art, the sweep-type sensor employs the sweep sensing method without exception, and therefore, requires a user to slide his/her finger for sensing. Conversely, the area-type sensor employs the area sensing method without exception, and therefore, does not require the user to move the finger. For increasing the sensing accuracy, therefore, the user must know the type of the sensor or the sensing method employed therein. This causes inconvenience to the users.

In the conventional technique, the sensing of the fingerprint is performed for only the purpose of collation, and an additional operation by the user is required for activating a device by utilizing a result of the sensing, or for starting execution of an application program. This impedes operability and convenience.

### SUMMARY OF THE INVENTION

An object of the invention is to provide an image collating apparatus, an image collating method and an image collating program, which allow appropriately selection of the sweep sensing method and the area sensing method while using the same sensor, as well as a computer-readable recording medium recording the image collating program.

Another object of the invention is to provide an image collating apparatus, an image collating method and an image collating program, which can use a result of selection of sensing methods or a result of collation for another purpose, as well as a computer-readable recording medium recording the image collating program.

For achieving the above objects, an image collating apparatus according to an aspect of the invention, includes an image input unit including a sensor, and allowing input of an image of a target via the sensor in any one of a position-fixed manner fixing a relative positions of the sensor and the target, and a position-changing manner changing the relative positions of the sensor and the target; a position-fixed collating unit collating the image obtained by the image input unit in the position-fixed manner with a reference image; a position-changing collating unit collating the image obtained by the image input unit in the position-changing manner with the reference image; a determining unit determining, based on a time-varying change in the relative position relationship between the sensor and the target during input of the image of the target by the image input unit, whether the image obtained by the image input unit is to be collated by the position-fixed collating unit or the position-changing collating unit; and a selecting unit selectively enabling one of the position-fixed collating unit and the position-changing collating unit according to a result of determination by the determining unit.

More specifically, the sensor is equivalent or similar to a sweep type sensor, and is operable in both a position-changing manner corresponding to the conventional sweep sensing method executed by sliding a finger and a position-fixed manner corresponding to the area sensing method executed without sliding the finger.

In the above area sensing method, the image of the target such as a fingerprint is read with the sweep type sensor or a sensor similar to it. In contrast to the area sensing method, in which a large area of the fingerprint is read, the area sensing method is executed by collating a narrow target, and therefore cannot achieve a high collation accuracy. However, the area sensing method can offer high convenience to users. Selection may be made according to purposes such that the sweep sensing method is selected for the purpose requiring high confidentiality, and the area sensing method is selected for improving convenience if required confidentiality is rather low.

The sensor used in the apparatus is the same as or similar to a conventional sensor of the sweep type, and therefore is less expensive than an apparatus of using an area type sensor.

According to the above image collating apparatus, the position determining unit determines whether the input image of the target is to be collated by the position-fixed collating unit or the position-changing collating unit, based on the time-varying change in the relative position relationship between the sensor and the target during input of the image of the target through the sensor by the image input unit and the sensor. According to the result of the determination, the selecting unit selectively enables the position-fixed collating unit and the position-changing collating unit.

Without externally applying particular reference for selection, therefore, the image collating apparatus can appropriately select the sweep sensing method in the position-changing manner and the area sensing method in the position-fixed manner based on the time-varying change in the relative position relationship between the target and the sensor, while using the same sensor in both the methods.

According to another aspect of the invention, an image collating apparatus includes an image input unit including a sensor, and allowing input of an image of a target via the sensor in any one of a position-fixed manner fixing a relative positions of the sensor and the target, and a position-changing manner changing the relative positions of the sensor and the target; a position-fixed collating unit collating the image obtained by the image input unit in the position-fixed manner with a reference image; a position-changing collating unit collating the image obtained by the image input unit in the position-changing manner with the reference image; a determining unit determining, based on given predetermined information, whether the image obtained by the image input unit is to be collated by the position-fixed collating unit or the position-changing collating unit; and a selecting unit selectively enabling the position-fixed collating unit and the position-changing collating unit according to a result of determination by the determining unit. A predetermined control target corresponding to a result of the selection by the selecting unit is controlled among the multiple kinds of control-targets.

According to the above image collating apparatus, it is determined based on the given predetermined information whether the input image is to be collated by the position-fixed collating unit or the position-changing collating unit. According to the result of the determination, the position-fixed collating unit and the position-changing collating unit are selectively enabled, and thereby the predetermined control target, which corresponds to the result of the selection, is controlled among the multiple kinds of control targets.

Therefore, the control target can be controlled depending on the result of the selection and, in other words, depending on the manner of image input.

Preferably, the determining unit determines whether the image obtained by the image input unit is to be collated by the position-fixed collating unit or the position-changing collating unit, depending on whether an amount of change in said relative position relationship reaches a predetermined value after elapsing of a predetermined time from start of the input of the image by the image input unit.

Since the determination is performed after elapsing of the predetermined time from the start of input by the image input unit, the determination can be performed after the image input becomes stable. This can prevent lowering of the collation accuracy.

Preferably, the determining unit includes an input determining unit determining whether the image is input by the image input unit or not. When the input determining unit determines that the image is not input, the determining unit determines whether the image obtained by the image input means is to be collated by the position-fixed collating means or the position-changing collating means, depending on whether an amount of change in the relative position relationship reaches a predetermined value or not.

Therefore, the determination starts when the target moves away from the sensor to complete the input of image. Accordingly, it is possible to prevent mixing of a disturbance, which is caused by an input image of another target, into the collating processing.

Preferably, the determining unit includes an input determining unit determining whether the image is input by the image input unit or not. When the input determining unit determines that the image is input, and an amount of change in the relative position relationship reaches a predetermined amount, the determining means determines that the image obtained by the image input unit is to be collated by the position-changing collating unit. When the input determining unit determines that the image is not being input, and the amount of change in the relative position relationship does not reach the predetermined amount, the determining means determines that the image obtained by the image input unit is to be collated by the position-fixed collating unit.

Accordingly, the position-changing collating unit can perform the collation when the manner of inputting the image by sliding the target on the sensor is employed, and thus when the image is input, and the amount of change in the relative position relationship reaches the predetermined value. When the manner of inputting the image without sliding the target on the sensor is employed, and thus when the image is not input, and the amount of change in the relative position relationship does not reach the predetermined value, the position-fixed collating unit can perform the collation.

Preferably, the control target corresponding to a result of the selection by the selecting unit is controlled among the multiple kinds of control targets.

Accordingly, when the selecting unit made the selection, the control target of the kind corresponding to a result of the selection is controlled without a particular instruction of the user.

Preferably, the predetermined control target is controlled based on a result of the collation by one of the position-fixed collating unit and the position-changing collating unit selectively enabled by the selecting unit.

Accordingly, the predetermined control target can be controlled base on the result of the collation by the collating unit selectively enabled by the selecting unit without a particular instruction of the user.

Preferably, reference is made to the result of collation for at least the purposes of activating the control target and determining the procedure of controlling the control target.

Therefore, activation of the control target and determination of the control sequence can be performed by utilizing the result of one collating operation by the collating unit enabled by the selecting unit, and it is not necessary to execute independent image collation for each of such activation and determination.

Preferably, the predetermined information represents a time-varying change in the relative position relationship between the sensor and the target during input of the image of the target by the image input unit.

Therefore, it is not necessary to provide externally particular information for selection.

Preferably, the predetermined information is preset information. Therefore, the information for selection can be set in advance in a desired manner.

Preferably, the predetermined information represents a purpose of the collation. Therefore, the collating unit corresponding to the purpose of collation can be enabled.

Preferably, the predetermined information represents a confidentiality level. Therefore, the collating unit corresponding to the confidentiality level can be selectively enabled.

An image collating method according to still another aspect of the invention includes an image input step capable of inputting an image of a target via a sensor prepared in advance in either of a position-fixed manner of fixing the sensor in a position relative to the target or a position-changing manner of changing the relative positions of the sensor and the target; a position-fixed collating step of collating the image obtained according to the position-fixed manner in the image input step with a reference image; a position-changing collating step of collating the image obtained according to the position-changing manner in the image input step with the reference image; a determining step of determining whether the image obtained in the image input step is to be collated in the position-fixed collating step or the position-changing collating step based on a time-varying change in a relative position between the sensor and the target during obtaining of the image of the target in the image input step; and a selecting step of selectively enabling the position-fixed collating step and the position-changing collating step according to a result of the determination in the determining step.

An image collating method according to yet another aspect of the invention includes an image input step capable of inputting an image of a target via a sensor prepared in advance in either of a position-fixed manner of fixing the sensor in a position relative to the target or a position-changing manner of changing the relative positions of the sensor and the target; a position-fixed collating step of collating the image obtained according to the position-fixed manner in the image input step with a reference image; a position-changing collating step of collating the image obtained according to the position-changing manner in the image input step with the reference image; a determining step of determining, based on given predetermined information, whether the image obtained in the image input step is to be collated in the position-fixed collating step or the position-changing collating step; a selecting step of selectively enabling the position-fixed collating step and the position-changing collating step according to a result of the determination in the determining step; and a step of controlling a predetermined control target corresponding to a result of the selection in the selecting step among a plurality of control targets.

An image collating program according to further another aspect of the invention is an image collating program for causing a computer to execute the foregoing image collating method.

A recording medium according to further aspect of the invention is a computer-readable recording medium bearing the foregoing image collating program.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B are block diagrams showing a structure of an image collating apparatus according to embodiments.

FIG. 2 shows an example of a configuration of a computer implementing an image collating apparatus according to the embodiments.

FIGS. 3A and 3B illustrate sensing of fingerprint data with a fingerprint sensor operable in both the sweep method and the area method.

FIG. 4 is a flowchart entirely illustrating an image collating method according to the embodiments.

FIG. 5 is a flowchart illustrating processing in step T3 in FIG. 4.

FIG. 6 is a flowchart illustrating processing of calculating a relative position relationship between snapshot images in the image collating processing according to the embodiments.

FIGS. 7A-7D illustrate a procedure in FIG. 6.

FIG. 8 is a flowchart illustrating collating processing in the case where fingerprint input and collation are performed in an area method.

FIG. 9 is a flowchart illustrating collating processing in the case where fingerprint input and collation are performed in a sweep method.

FIG. 10 is a flowchart illustrating an example of a processing procedure of step T13 in FIG. 4.

FIG. 11 is a flowchart illustrating another example of a processing procedure of step T13 in FIG. 4.

FIG. 12 is a flowchart illustrating still another example of a processing procedure of step T13 in FIG. 4.

FIG. 13 is a flowchart of a control procedure based on a result of image collation.

FIG. 14 is a flowchart entirely illustrating another image collating method.

FIGS. 15A and 15B illustrate an image-to-image matching method in a prior art.

FIGS. 16A-16D illustrate an image feature matching method in a prior art.

FIGS. 17A-17D schematically illustrate minutiae, which are image features used in the prior art.

FIGS. 18A-18C illustrate results of search for a position of the highest matching score in connection with a plurality of partial area in a pair of fingerprint images obtained from the same fingerprint as well as a distribution of movement vectors in the respective partial areas.

FIG. 19 illustrates a sweep sensing method, which is a conventional fingerprint image input method.

FIG. 20 is an area sensing method, which is a conventional fingerprint image input method.

### DESCRIPTION OF THE PREFERRED EMBODIMENTS

In an image collating apparatus according to each embodiment, a sensor is equivalent or similar to a sweep type sensor, and can operate selectively in a sweep sensing method and an area sensing method. Accordingly, an additional cost is not required for the sensor, and it is possible to suppress a cost of the apparatus as compared with the case of using a conventional sweep type sensor or a sensor similar to it as well as an area type sensor. Further, it is possible to select manners such that a manner achieving high precision is used for the case of reading a fingerprint by sliding a finger, and thus for the case where high confidentiality is required, and a simple manner is used for the case of reading a fingerprint without sliding a finger, and thus for a convenience-oriented case. Though image data, which is obtained from a fingerprint by sensing, will be described as an exemplary image data to be collated, the image data is not limited thereto, and the present invention may be applicable to image data of other biometrics that are similar among samples (individuals) but not identical.

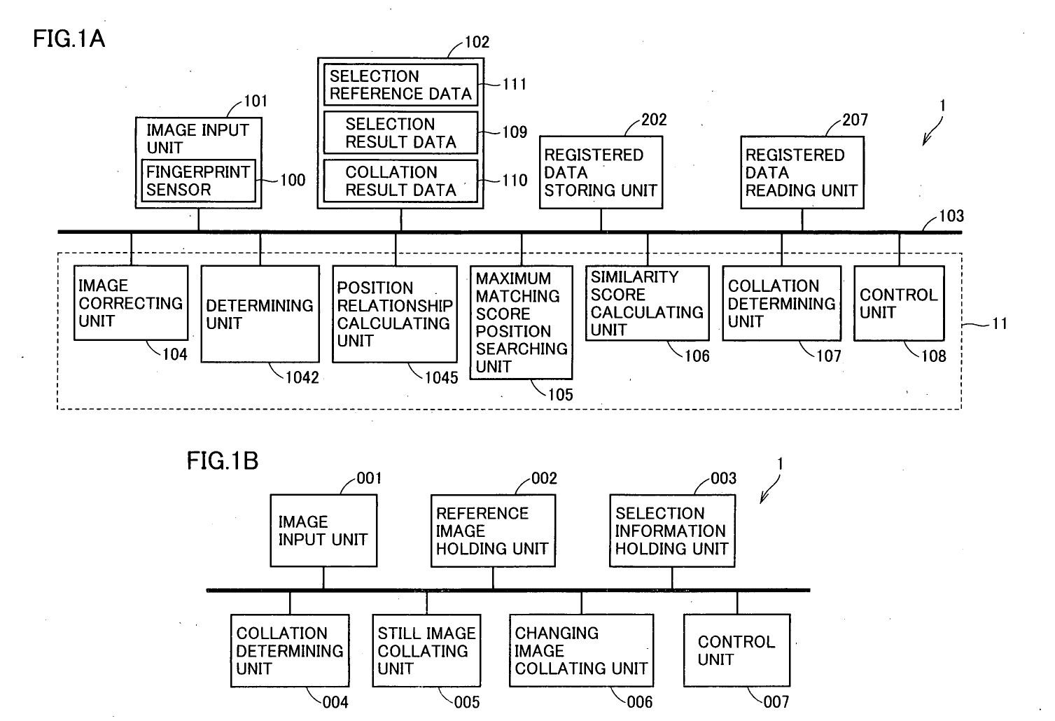

In each of image collating apparatuses 1 of embodiments, which are shown in FIGS. 1A and 1B, respectively, units or portions correspond to each other as follows. An image input unit 001 corresponds to an image input unit 101, a reference image holding unit 002 corresponds to registered data storing unit 202, and a selection information holding unit 003 corresponds to a memory 102. A collation determining unit 004 corresponds to a determining unit 1042, which determines the fingerprint input and collation method. A still image collating unit 005 corresponds to a maximum matching score position searching unit 105, a similarity score calculating unit 106, which calculates a movement-vector-based similarity score, and a collation determining unit 107. A changing image collating unit 006 corresponds to a position relationship calculating unit 1045, which calculates a relative position relationship between snapshot images, maximum matching score position searching unit 105, similarity score calculating unit 106 and collation determining unit 107. Further, memory 102 and a control unit 108 in FIG. 1A has a function of controlling storage regions for respective units in FIG. 1B and the respective units. Control unit 007 corresponds to control unit 108. A registered data reading unit 207 reads data from registered data storing unit 202. An image correcting unit 104 corrects input image data.

### First Embodiment

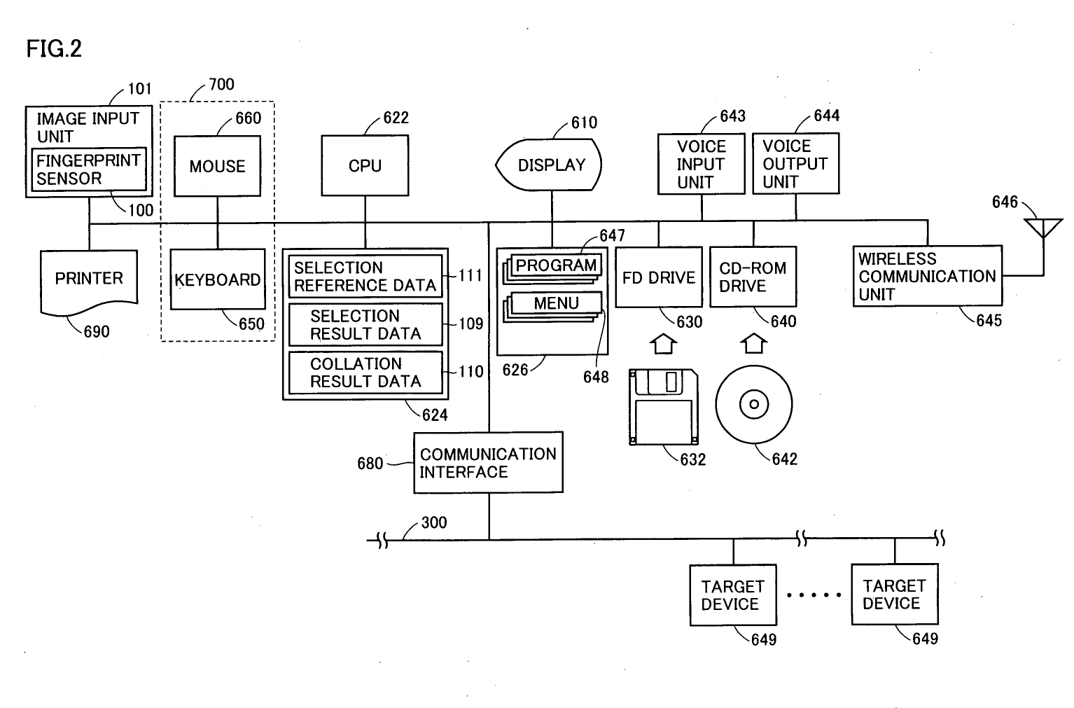

FIG. 2 shows a configuration of a computer in which the image collating apparatus in accordance with various embodiments is mounted. Referring to FIG. 2, the computer includes an image input unit 101, a display 610 such as a CRT (Cathode Ray Tube) or a liquid crystal display, a CPU (Central Processing Unit) 622 for central management and control of the computer itself, a memory 624 including an ROM (Read Only Memory) or an RAM (Random Access Memory), a fixed disk 626, an FD drive 630 on which an FD (flexible disk) 632 is detachably mounted and which accesses to FD 632 mounted thereon, a CD-ROM drive 640 on which a CD-ROM (Compact Disc Read Only Memory) is detachably mounted and which accesses to mounted CD-ROM 642, a communication interface 680 for connecting the computer to a communication network 300 for establishing communication, a printer 690, and an input unit 700 having a keyboard 650 and a mouse 660. Further, the apparatus includes a wireless communication unit 645 for wireless communication connected to an antenna 646, a voice input unit 643 including a microphone for voice input, and a voice output unit 644 including a loud speaker for voice output. These components are connected through a bus for communication.

A plurality of target devices 649 are connected to a communication network 300. Based on selection result data 109 and collation result data 110 representing results of image collating processing, which will be described below, CPU 622 selects and controls one of more of the plurality of target devices 649. Although the plurality of target devices 649 are connected to network 300, these may be connected by wireless communication via antennas 646.

The computer may be provided with a magnetic tape apparatus accessing to a cassette type magnetic tape that is detachably mounted thereto.

Although FIG. 2 shows a desktop computer, a computer arranged in a cellular phone or the like may be employed, in which case mouse 660, printer 690 and communication interface 680 are removed.

Referring to FIG. 1A, image collating apparatus 1 includes image input unit 101, memory 102 that corresponds to memory 624 or fixed disk 626 shown in FIG. 2, registered data storing unit 202, registered data reading unit 207, a collation processing unit 11 and a bus 103 mutually connecting these portions and units for communication. Collating unit 11 includes image correcting unit 104, determining unit 1042, position relationship calculating unit 1045, maximum matching score position searching unit 105, similarity score calculating unit.106, collation determining unit 107 and control unit 108. Functions of these units in collating unit 11 are realized when corresponding programs are executed.

Memory 102 or corresponding memory 624 stores selection result data 109, collation result data 110 and selection reference data 111. Fixed data disk 626 stores a plurality of programs 647, which are read and executed by CPU 622, as well as a plurality of menu data 648 displayed on display 610.

Image input unit 101 includes a fingerprint sensor 100 (which will be merely referred to as “sensor 100” hereinafter), and outputs a fingerprint image data that corresponds to the fingerprint read by sensor 100. Sensor 100 may be an optical, a pressure-type, a static capacitance type or any other type sensor.

Sensor 100 in image input unit 101 can obtain the fingerprint data by sensing in the sweep method, and can also obtain the fingerprint data by sensing in the area method. Image data may be obtained by each sensing operation of sensor 100 in image input unit 101, i.e., by every reading of a sensing target, and thus may be obtained in a snapshot-like manner. This image data is referred to as “snapshot image data”. It is assumed that sensor 100 periodically reads the target while it is placed on sensor 100, and provides image data in response to every reading.

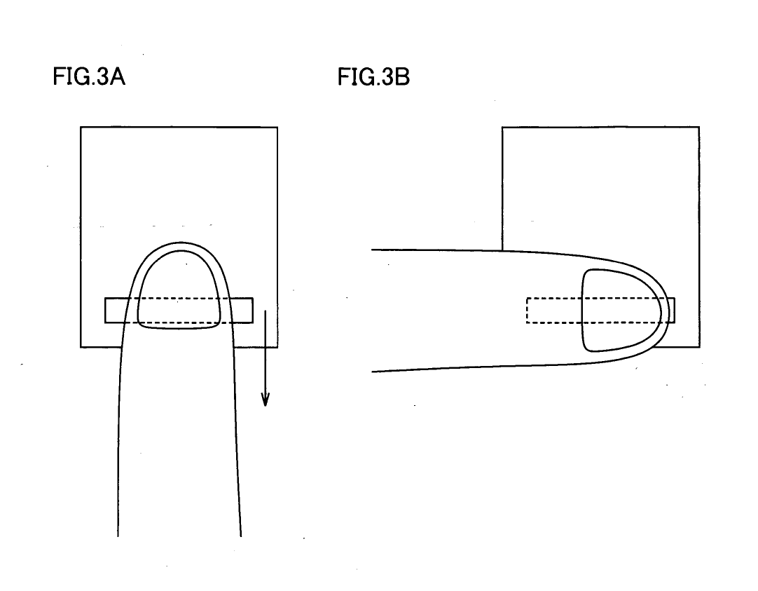

For performing the sensing in the sweep method, a finger is kept perpendicular to a narrow sensor as shown in FIG. 3A, and is moved downward (or upward) in a direction of an arrow to change the position relationship so that fingerprint data is obtained.

For performing the sensing in the area method, the finger is kept parallel to the narrow sensor as shown in FIG. 3B, and the fingerprint data is obtained while keeping this relative position relationship, i.e., while pressing the finger onto the sensor without moving it.

The sensor must have sizes, which allow sensing in the area method. For example, the sensor must have a lateral size (256 pixels), which is nearly 1.5 times larger a size of the finger, and a longitudinal size (64 pixels), which is nearly 0.25 times larger than the size of finger. It is assumed that ordinary sizes of the finger, which is a target of sensing, is determined in advance from measurements for determining the sizes of the sensor.

In the embodiment, the sensing in the area method is performed with sensor 100 having a longitudinal size, which is nearly 0.25 times larger than the size of finger. Therefore, this sensing cannot achieve a high collation accuracy, but requires a shorter processing time than the collation in the sweep method so that the sensing in the area method can be used for simple fingerprint collation, and can offer convenience to users. Conversely, the sensing in the sweep method requires a long processing time, but can achieve a high collation accuracy so that the sensing in the sweep method can be utilized for fingerprint collation requiring high confidentiality.

Memory 102 stores image data and various calculation results. Bus 103 is used for transferring control signals and data signals between the units. Image correcting unit 104 performs density correction of the fingerprint image data provided from image input unit 101. Maximum matching score position searching unit 105 uses a plurality of partial areas of one fingerprint image as templates, and searches for a position of the other fingerprint image that attains the highest matching score with respect to the templates. Namely, this unit serves as a so-called template matching unit. Using the information of the result of processing by maximum matching score position searching unit 105 stored in memory 102, similarity score calculating unit 106 calculates the movement-vector-based similarity score, which will be described later. Collation determining unit 107 determines a match/mismatch, based on the similarity score calculated by similarity score calculating unit 106. Control unit 108 controls processes performed by various units of collating unit 11.

Registered data storing unit 202 stores in advance only the image data, which is used for collation, and is obtained from an image different from the snapshot image to be collated. In the image collating processing, registered data reading unit 207 reads the image data from registered data storing unit 202 for using it as reference image data to be collated with the input image data. In each embodiment, although the reference image data is obtained from registered data reading unit 207, it may be externally obtained every time the collation processing is to be performed.

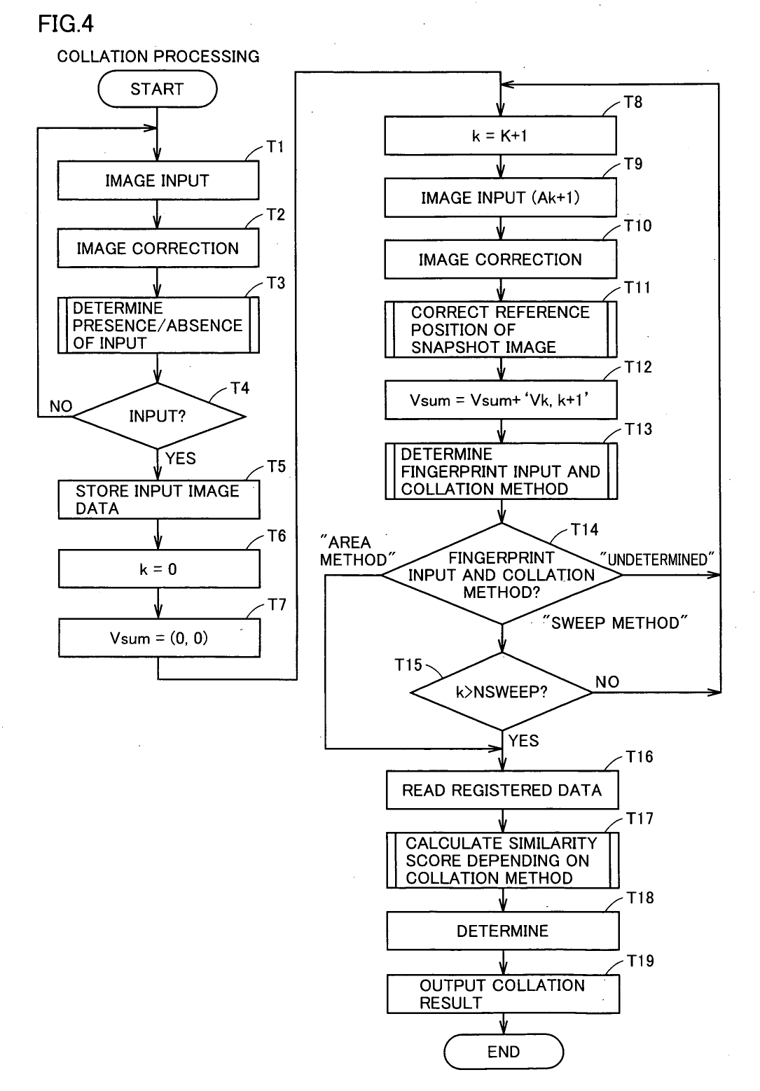

The image collating method in image collating apparatus 1 shown in FIG. 1 will now be described with reference to a flowchart of FIG. 4.

First, the apparatus is on standby until the finger is placed on sensor 100 (steps T1-T4).

First, control unit 108 transmits an image input start signal to image input unit 101, and thereafter waits for reception of an image input end signal. When image input unit 101 receives image data A1 for collation via sensor 100, it stores the image at a prescribed address of memory 102 through bus 103 (step T1). After the input of image data A1 is completed, image input unit 101 transmits the image input end signal to control unit 108.

Then, control unit 108 transmits an image correction start signal to image correcting unit 104, and thereafter, waits for reception of an image correction end signal. In most cases, the input image has uneven image quality, as tones of pixels and overall density distribution vary because of variations in characteristics of image input unit 101, dryness of fingerprints and pressure with which fingers are pressed. Therefore, it is not appropriate to use the input image data directly for collation. Image correcting unit 104 corrects the image quality of input image to suppress variations of conditions when the image is input (step T2). Specifically, for the overall image corresponding to the input image or small areas obtained by dividing the image, histogram planarization, as described in Computer GAZOU SHORI NYUMON (Introduction to computer image processing), SOKEN SHUPPAN, p.98, or image thresholding (binarization), as described in Computer GAZOU SHORI NYUMON (Introduction to computer image processing), SOKEN. SHUPPAN, pp. 66-69, is performed on image data A1 stored in memory 102.

After the end of image correction of image data A1, image correcting unit 104 transmits the image correction end signal to control unit 108.

The foregoing processing will be repeated until the input of data (steps T3 and T4).

The processing in step ST3 will now be described with reference to FIG. 5. The number of black pixels (corresponding to ridges of the fingerprint image) in the image is divided by the number of whole pixels including white pixels in a background, and a value “Bratio” representing a ratio of the black pixels is calculated (step SB001). If value “Bratio” exceeds a certain value “MINBratio”, it is determined that a finger is placed on sensor 100 and the input is provided so that “Y” is returned to the original processing. Otherwise, it is determined that there is no input, and “N” is returned (steps SB002-SB004).

Referring to FIG. 4 again, when “Y” is returned from the processing in step T3, image data A1, which is input and corrected, is stored at a certain address in memory 102 (step T5), and a variable “k” and a movement cumulative vector “Vsum”, which are stored at predetermined addresses in memory 102 for controlling the processing in FIG. 4, are initialized to 0 and (0, 0) in steps T6 and T7, respectively. Subsequently, one is added to a value of variable “k” (step T8).

Thereafter, (k+1)th image data Ak+1 is provided, and is corrected similarly to steps T1 and T2 (steps T9 and T11).

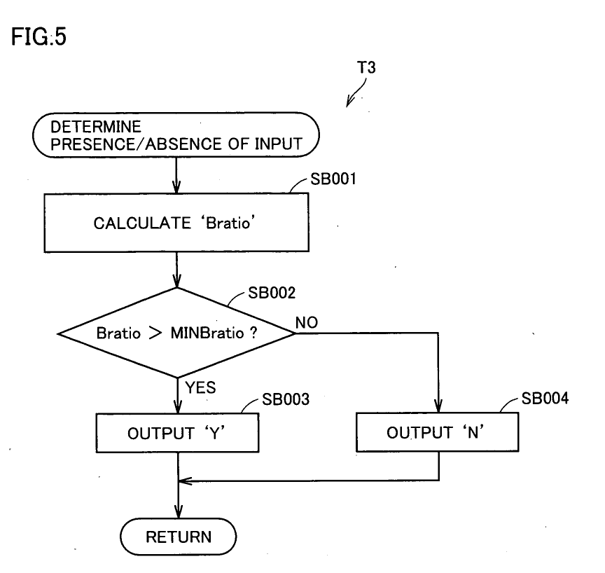

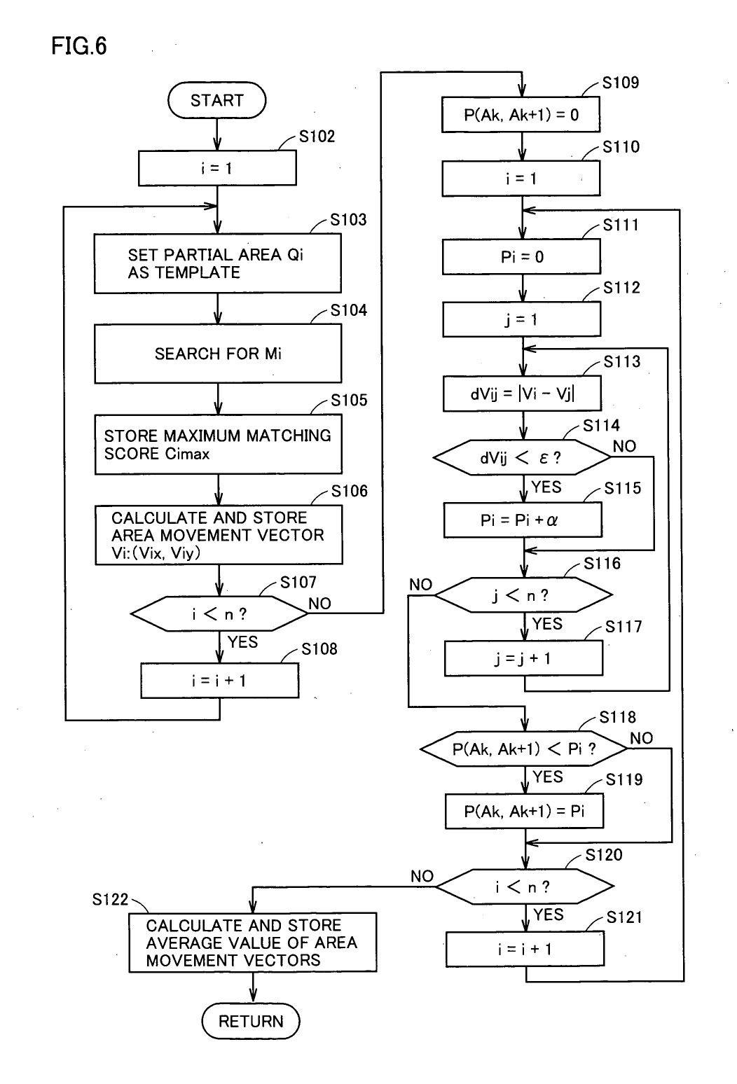

Movement vector “Vk+1” is calculated from last image data Ak and current image data Ak+1 (step T11). This will now be described with reference to a flowchart of FIG. 6.

According to the flowchart of FIG. 6, processing is performed to calculate a movement vector “Vk,k+1” representing a relative position relationship between last image data Ak and current image data Ak+1 (step T11).

Control unit 108 transmits a template matching start signal to position relationship calculating unit 1045, and waits for reception of a template matching end signal. Position relationship calculating unit 1045 starts template matching processing represented by steps S101 to S108.

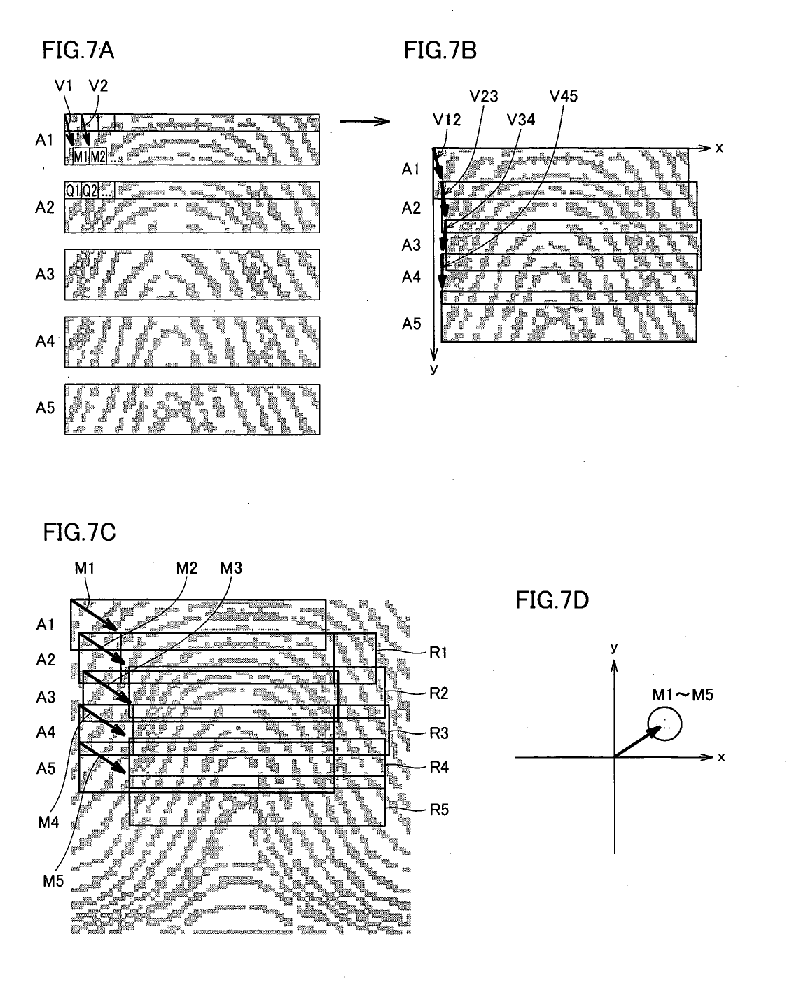

This template matching processing is basically performed for searching for the maximum matching score position, and thus for searching for a partial area of snapshot image data Ak, which matches with each of the plurality of partial images of snapshot image data Ak+1 to the highest extent. For example, snapshot image data A1-A5 in FIG. 7 are processed to search for a position of the partial image among partial images M1, M2, in snapshot image A1, which matches with each of the plurality of partial images Q1, Q2, . . . in snapshot image data A2 to the highest extent. This will now be described in greater detail.

In step S102, variable “i” of the counter is initialized to 1. In step S103, an image of the following partial area Qi is set as a template to be used for the template matching. Partial area Qi is defined by dividing a area corresponding to four pixel lines on the image of image data Ak+1, and has a size of 4 pixels by 4 pixels.

Though the partial area Qi has a rectangular shape for simplicity of calculation, the shape is not limited thereto. In step S104, processing is performed to search for a position, where the image of image data Ak exhibits the highest matching score with respect to the template set in step S103, i.e., the position where matching of data in the image is achieved to the highest extent. More specifically, it is assumed that partial area Qi used as the template has an image density of Qi(x, y) at coordinates (x, y) defined based on its upper left corner, and image data Ak has an image density of Ak(s, t) at coordinates (s, t) defined based on its upper left corner. Also, partial area Qi has a width w and a height h, and each of pixels of images Qi and Ak has a possible maximum density of V0. In this case, a matching score Ci(s, t) at coordinates (s, t) of the image of image data Ak can be calculated based on density differences of respective pixels according to the following equation (1).

$$Ci ( s , t ) = {\sum }_{y = 1}^{h} {\sum }_{x = 1}^{w} ( V0 - \vert Qi ( x , y ) - Ak ( s + x , t + y ) \vert ) \qquad ( 1 )$$

In the image of image data Ak, coordinates (s, t) are successively updated and matching score C(s, t) in coordinates (s, t) is calculated. A position having the highest value is considered as the maximum matching score position, the image of the partial area at that position is represented as partial area Mi, and the matching score at that position is represented as maximum matching score Cimax. In step S105, maximum matching score Cimax in the image of image data Ak for partial area Qi calculated in step S104 is stored at a prescribed address of memory 102. In step S106, a movement vector Vi is calculated in accordance with the following equation (2), and is stored at a prescribed address of memory 102. As already described, processing is effected based on partial area Qi corresponding to position P set in the image of image data Ak, and the image of image data Ak is scanned to determine a partial area Mi in a position M exhibiting the highest matching score with respect to partial area Qi. A vector from position P to position M thus determined is referred to as the “movement vector”.
Vi=(Vix, Viy)=(Mix−Rix, Miy−Riy) (2)

In the above equation (2), variables Qix and Qiy are x and y coordinates of the reference position of partial area Qi, and correspond, by way of example, to the upper left corner of partial area Qi in the image of image data Ak. Variables Mix and Miy are x and y coordinates of the position of maximum matching score Cimax, which is the result of search of partial area Mi, and correspond, by way of example, to the upper left corner coordinates of partial area Mi located at the matched position in the image of image data Ak.

In step S107, it is determined whether counter variable “i” is not larger than a total number “n” of partial areas or not. If the value of variable “i” is not larger than a value of a variable n, which represents the total number “n” of the partial areas, the flow proceeds to step S108, and otherwise, the process proceeds to step S109. In step S108, 1 is added to the value of variable “i”. Thereafter, as long as the value of variable “i” is not larger than the value of variable n, steps S103 to S108 are repeated. Namely, for each partial area Qi, template matching is performed to calculate maximum matching score Cimax of each partial area Qi and movement vector Vi.

Maximum matching score position searching unit 105 stores maximum matching score Cimax and movement vector Vi for every partial area Qi, which are calculated successively as described above, at prescribed addresses of memory 102, and thereafter transmits the template matching end signal to control unit 108 to end the processing.

Thereafter, control unit 108 transmits a similarity score calculation start signal to similarity score calculating unit 106, and waits for reception of a similarity score calculation end signal. Similarity score calculating unit 106 calculates the similarity score through the process of steps S109 to S124 of FIG. 6, using information such as movement vector Vi and maximum matching score Cimax of each partial area Qi obtained by the template matching and stored in memory 102.

The similarity score calculating processing is basically performed such that the similarity score attained between two image data Ak and Ak+1 is calculated by using the maximum matching position, which is obtained by the foregoing template matching processing, and corresponds to each of the plurality of partial images. This processing will now be described in greater detail. Since the data of snapshot images relates to the same person, and the similarity score calculating processing is not required for such images.

In step S109, similarity score P(Ak, Ak+1) is initialized to 0. Here, similarity score P(Ak, Ak+1) is a variable storing the degree of similarity between image data Ak and Ak+1. In step S110, an index “i” of movement vector Vi used as a reference is initialized to 1. In step S111, similarity score Pi related to movement vector Vi used as the reference is initialized to 0. In step S112, an index “j” of movement vector Vj is initialized to 1. In step S113, vector difference dVij between reference movement vector Vi and movement vector Vj is calculated in accordance with the following equation (3).
dVij−|Vi−Vj|=sqrt((Vix−Vjx)²+(Viy−Vjy)²) (3)

Here, variables Vix and Viy represent components in x and y directions of movement vector- Vi, respectively, and variables Vjx and Vjy represent components in x and y directions of movement vector Vj, respectively. Variable “sqrt(X)” represents a square root of X, and X\hat{ }2 represents calculation of square of X.

In step S114, vector difference dVij between movement vectors Vi and Vj is compared with a prescribed constant value “ε”, and it is determined whether movement vectors Vi and Vj can be regarded as substantially the same vectors or not. If vector difference dVij is smaller than the constant value “ε”, movement vectors Vi and Vj are regarded as substantially the same, and the flow proceeds to step S115. If the difference is larger than the constant value, the movement vectors cannot be regarded as substantially the same, and the flow proceeds to step S116. In step S115, similarity score Pi is incremented in accordance with the following equations (4) to (6).
Pi=Pi+α (4)
α=1 (5)
α=Cjmax (6)

In equation (4), variable “α” is a value for incrementing similarity score Pi. If α is set to 1 as represented by equation (5), similarity score Pi represents the number of partial areas that have the same movement vector as reference movement vector Vi. If α is equal to Cjmax as represented by equation (6), similarity score Pi is equal to the total sum of the maximum matching scores obtained through the template matching of partial areas that have the same movement vectors as the reference movement vector Vi. The value of variable “α” may be reduced depending on the magnitude of vector difference dVij.

In step S116, it is determined whether the value of index “j” is smaller than the value of variable “n” or not. If the value of index “j” is smaller than the value of variable “n”, the flow proceeds to step S118. If it is larger, the flow proceeds to step S117. In step S117, the value of index “j” is incremented by 1. By the process from step S111 to S117, similarity score Pi is calculated, using the information of partial areas determined to have the same movement vector as the reference movement vector Vi. In step S118, similarity score Pi using movement vector Vi as a reference is compared with variable P(Ak, Ak+1). If similarity score Pi is larger than the largest similarity score (value of variable P(Ak, Ak+1)) obtained by that time, the flow proceeds to step S119, and otherwise the flow proceeds to step S120.

In step S119, variable P(Ak, Ak+1) is set to a value of similarity score Pi using movement vector Vi as a reference. In steps S118 and S119, if similarity score Pi using movement vector Vi as a reference is larger than the maximum value of the similarity score (value of variable P(Ak, Ak+1)) calculated by that time using anther movement vector as a reference, the reference movement vector Vi is considered to be the best reference among movement vectors Vi, which have been represented by index “i”.

In step S120, the value of index “i” of reference movement vector Vi is compared with the total number (value of variable “n”) of partial areas. If the value of index “i” is smaller than the number “n” of partial areas, the flow proceeds to step S121, in which value of index “i” is incremented by 1.

By the processing from step S109 to step S121, similarity between image data Ak and Ak+1 is calculated as the value of variable P(Ak, Ak+1). Similarity score calculating unit 106 stores the value of variable P(Ak, Ak+1) calculated in the above described manner at a prescribed address of memory 102, and performs the processing in step S122 to calculate an average value Vk,k+1 of the area movement vector in the following equation (7)

$$Vk , k + 1 = ( {\sum }_{i = 1}^{n} Vi ) / n \qquad ( 7 )$$

Average value Vk,k+1 of area movement vectors is calculated for the following purpose. The relative position relationship between the images of snapshot image data Ak and Ak+1 can be calculated based on the average value of the set of movement vectors Vi of respective partial areas Qi of each snapshot image. For this calculation, the above average value Vk,k+1 is calculated. For example, referring to FIGS. 7A and 7B, an average vector V12 is obtained from area movement vectors V1, V2, Vectors V23, V34 and V45 are likewise calculated from images A2 and A3, from images A3 and A4, and from images A4 and A5, respectively.

After obtaining average vector Vk,k+1, control unit 108 transmits the calculation end signal to position relationship calculating unit 1045 to end the processing.

Referring to FIG. 4, movement vector “Vk,k+1” obtained in step T11 is added to vector Vsum formed of cumulative sum of the movement vectors on memory 102, and prepares new vector Vsum formed of the result of this addition (step T12).

Then, the fingerprint input and collation method are determined (step T13). Contents of such processing will be described later in greater detail.

In step T14, processing in step S16 is selected when the result of determination in step T13 represents the area method. When the sweep method is represented, processing in step T15 is selected. When the result represents “undetermined”, the processing returns to step T8.

In the sweep method, when it is determined in step T15 that the number of provided snapshot images has reached the prescribed value represented by variable “NSWEEP”, next processing is performed in step T16. When it is determined that the number has not reached variable “NSWEEP”, the processing returns to step T8 to take in new data. The number represented by variable “NSWEEP” corresponds to the number of snapshot images required for achieving a prescribed collation accuracy.

Then, control unit 108 transmits a registered data read start signal to registered data reading unit 207, and waits for reception of a registered data read end signal.

When registered data reading unit 207 receives the registered data read end signal, it reads data of partial area Ri in the image of image data B, which is the reference image data, from registered data storing unit 202, and stores it at the prescribed address in memory 102 (step T16).

Thereafter, the collation processing and determination are effected on both the images of image data Ak and B in steps S17 and T18. The processing performed when the area method is selected and the processing performed when the sweep method is selected will now be described independently of each other.

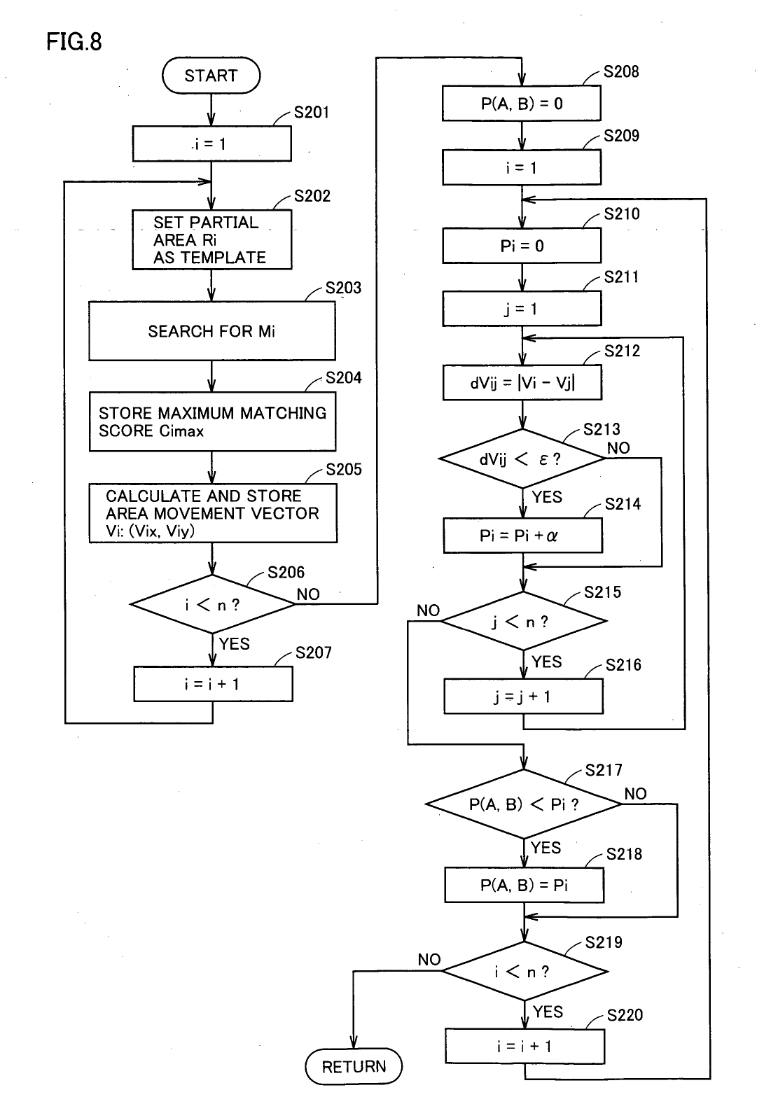

When the area method is selected in step T14, the input image data Ak is handled as image data A, and is collated with image data B. The manner of this processing will now be described according to a flowchart of FIG. 8.

Control unit 108 transmits a template matching start signal to maximum matching score position searching unit 105, and waits for reception of a template matching end signal. Maximum matching score position searching unit 105 starts the template matching process represented by steps S201 to S207.

This template matching processing is performed, e.g., for determining partial areas M1, M2, . . . Mn in FIG. 16B, to which respective partial areas R1, R2, . . . Rn in FIG. 16A move.

In step S201, variable “i” of the counter is initialized to 1. In step S202, the image of the partial area, which is defined as partial area Ri in the image of image data A, is set as a template to be used for template matching.

Though partial area Ri has a rectangular shape for simplicity of calculation, the shape is not limited thereto. In step S203, processing is performed to search for a position, where the image of image data B exhibits the highest matching score with respect to the template set in step S202, i.e., the position where matching of data in the image is achieved to the highest extent. More specifically, it is assumed that partial area Ri used as the template has an image density of Ri(x, y) at coordinates (x, y) defined based on its upper left corner, and image data B has an image density of B(s, t) at coordinates (s, t) defined based on its upper left corner. Also, partial area Ri has a width w and a height h, and each of pixels of image data A and B has a possible maximum density of V0. In this case, a matching score Ci(s, t) at coordinates (s, t) of the image of image data B can be calculated based on density differences of respective pixels according to the following equation (8).

$$Ci ( s , t ) = {\sum }_{y = 1}^{h} {\sum }_{x = 1}^{w} ( V0 - \vert Ri ( x , y ) - B ( s + x , t + y ) \vert ) \qquad ( 8 )$$

In the image of image data B, coordinates (s, t) are successively updated and matching score C(s, t) in coordinates (s, t) is calculated. A position having the highest value is considered as the maximum matching score position, the image of the partial area at that position is represented as partial area Mi, and matching score at that position is represented as maximum matching score Cimax. In step S204, maximum matching score Cimax in the image of image data B for partial image Ri calculated in step S203 is stored at a prescribed address of memory 102. In step S205, movement vector Vi is calculated in accordance with the following equation (9), and is stored at a prescribed address of memory 102.

As already described, processing is effected based on partial area Ri corresponding to position P set in the image of image data A, and the image of image data B is scanned to determine partial area Mi in position M exhibiting the highest matching score with respect to partial area Ri. A vector from position P to position M thus determined is referred to as the “movement vector”. This is because the image data B seems to have moved from image data A as a reference, as the finger is placed in various manners on the fingerprint sensor.
Vi=(Vix, Viy)=(Mix−Rix, Miy−Riy) (9)

In the above equation (9), variables Rix and Riy are x and y coordinates of the reference position of partial area Ri, and correspond, by way of example, to the upper left corner of partial area Ri in the image of image data A. Variables Mix and Miy are x and y coordinates of the position of maximum matching score Cimax, which is the result of search of partial area Mi, and correspond, by way of example, to the upper left corner coordinates of partial area Mi located at the matched position in the image of image data B (see partial areas M1-M5 and R1-R5 in FIGS. 7C and 7D).

In step S206, it is determined whether counter variable “i” is not larger than a value of variable n or not. If the value of variable “i” is not larger than number “n” of the partial areas, the flow proceeds to step S207, and otherwise, the process proceeds to step S208. In step S207, 1 is added to the value of variable “i”. Thereafter, as long as the value of variable “i” is not larger than the value of variable n, steps S202 to S207 are repeated. By repeating these steps, template matching is performed for each partial area Ri to calculate maximum matching score Cimax and movement vector Vi of each partial area Ri.

Maximum matching score position searching unit 105 stores maximum matching score Cimax and movement vector Vi for every partial area Ri, which are calculated successively as described above, at prescribed addresses of memory 102, and thereafter transmits the template matching end signal to control unit 108 to end the processing.

Thereafter, control unit 108 transmits a similarity score calculation start signal to similarity score calculating unit 106, and waits for reception of a similarity score calculation end signal. Similarity score calculating unit 106 calculates the similarity score through the process of steps S208 to S220 of FIG. 8, using information such as movement vector Vi and maximum matching score Cimax of each partial area Ri obtained by the template matching and stored in memory 102.

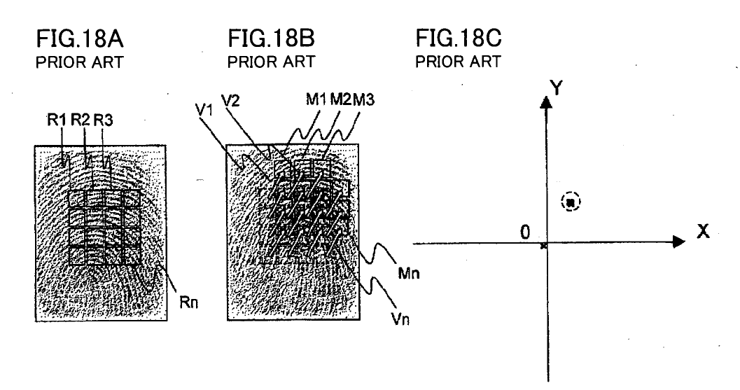

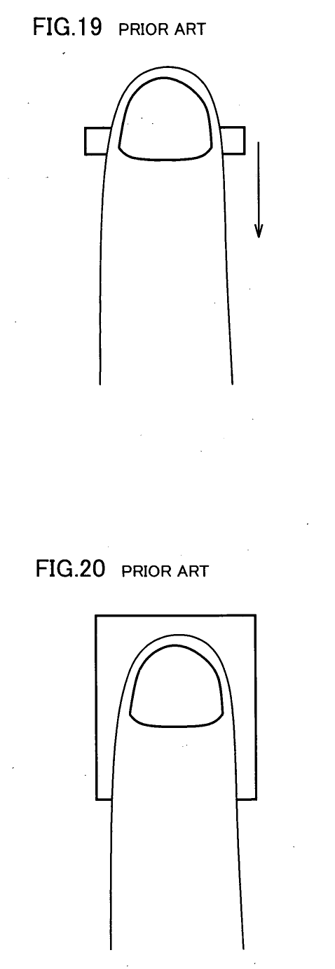

The similarity score calculating processing is performed for determining whether many vectors related to the partial area are located within a prescribed region illustrated by a broken line circle in FIG. 18C or not.

In step S208, similarity score P(A, B) is initialized to 0. Here, similarity score P(A, B) is a variable storing the degree of similarity between image data A and B. In step S209, index “i” of movement vector Vi used as a reference is initialized to 1. In step S210, similarity score Pi related to movement vector Vi used as the reference is initialized to 0. In step S211, index “j” of movement vector Vj is initialized to 1. In step S212, vector difference “dVij” between reference movement vector Vi and movement vector Vj is calculated in accordance with the following equation (10).
dVij=|Vi−Vj|=sqrt((Vix−Vjx)²+(Viy−Vjy)²) (10)

Here, variables Vix and Viy represent components in x and y directions of movement vector Vi, respectively, and variables Vjx and Vjy represent components in x and y directions of movement vector Vj, respectively. Variable “sqrt(X)” represents a square root of X.

In step S213, vector difference dVij between movement vectors Vi and Vj is compared with prescribed constant value “ε”, and it is determined whether movement vectors Vi and Vj can be regarded as substantially the same vectors or not. If vector difference dVij is smaller than the constant value “ε”, movement vectors Vi and Vj are regarded as substantially the same, and the flow proceeds to step S214. If the difference is larger than the constant value, the movement vectors cannot be regarded as substantially the same, and the flow proceeds to step S215. In step S214, similarity score Pi is incremented in accordance with the following equations (11) to (13).
Pi=Pi+α (11)
α=1 (12)
α=Cjmax (13)

In equation (11), variable “α” is a value for incrementing similarity score Pi. If α is set to 1 as represented by equation (12), similarity score Pi represents the number of partial areas that have the same movement vector as reference movement vector Vi. If α is equal to Cjmax as represented by equation (13), similarity score Pi is equal to the total sum of the maximum matching scores obtained through the template matching of partial areas that have the same movement vectors as the reference movement vector Vi. The value of variable “α” may be reduced depending on the magnitude of vector difference dVij.

In step S215, it is determined whether the value of index “j” is smaller than the value of variable n or not. If the value of index “j” is smaller than the value of variable n, the flow proceeds to step S216. If it is larger, the flow proceeds to step S217. In step S216, the value of index “j” is incremented by 1. By the process from step S210 to S216, similarity score Pi is calculated, using the information of partial areas determined to have the same movement vector as the reference movement vector Vi. In step S217, similarity score Pi using movement vector Vi as a reference is compared with variable P(A, B). If similarity score Pi is larger than the largest similarity score (value of variable P(A, B)) obtained by that time, the flow proceeds to step S018, and otherwise the flow proceeds to step S019.

In step S218, variable P(A, B) is set to a value of similarity score Pi using movement vector Vi as a reference. In steps S2 17 and S2 18, if similarity score Pi using movement vector Vi as a reference is larger than the maximum value of the similarity score (value of variable P(A, B)) calculated by that time using anther movement vector as a reference, the reference movement vector Vi is considered to be the best reference among movement vectors Vi, which have been represented by index “i”.

In step S219, the value of index “i” of reference movement vector Vi is compared with the number (value of variable n) of partial areas. If the value of index “i” is smaller than the value of number “n” of partial areas, the flow proceeds to step S220, in which value of index “i” is incremented by 1.

By the processing from step S208 to step S220, similarity between image data Ak and B is calculated as the value of variable P(A, B). Similarity score calculating unit 106 stores the value of variable P(A, B) calculated in the above described manner at a prescribed address of memory 102, and transmits a similarity score calculation end signal to control unit 108 to end the process.

Thereafter, control unit 108 transmits a collation determination start signal to collation determining unit 107, and waits for reception of a collation determination end signal. Collation determining unit 107 collates and determines (step T18). Specifically, the similarity score given as a value of variable P(A, B) stored in memory 102 is compared with a predetermined collation threshold T. If the result of comparison is P(A, B)≧T, it is determined that both the images of image data A and B are obtained from the same fingerprint, and a value, e.g., of 1 indicating “matching” is written as result data 110 of collation into a prescribed address of memory 102. Otherwise, the images are determined to be obtained from different fingerprints, and a value, e.g., of 0 indicating “mismatching” is written as result data 110 of collation into a prescribed address of memory 102. Thereafter, a collation determination end signal is transmitted to control unit 108, and the process ends.

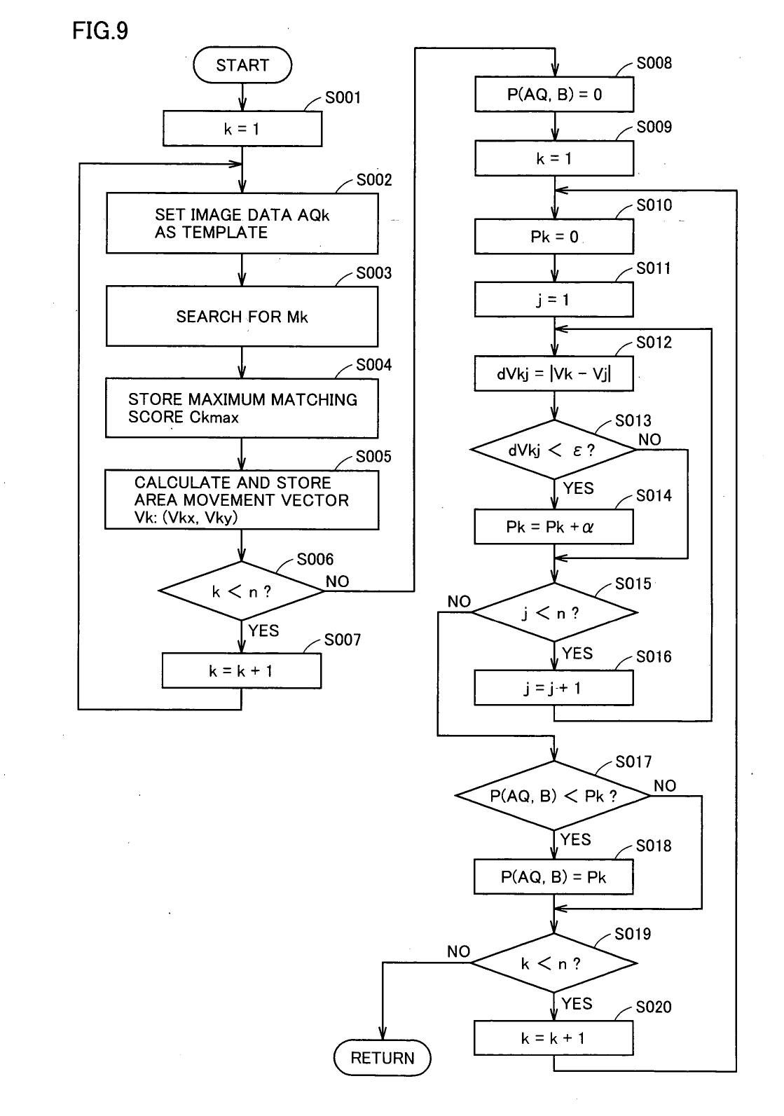

Processing of performing the similarity calculation and collation determination in the sweep method will now be described with reference to a flowchart of FIG. 9.

Control unit 108 transmits a template matching start signal to maximum matching score position searching unit 105, and waits for reception of a template matching end signal. Maximum matching score position searching unit 105 starts the template matching process represented by steps S001 S007.

The template matching processing is effected on a set of snapshot images reflecting the reference position, which is calculated by position relationship calculating unit 1045, to search for the maximum matching score position of each of the snapshot images. In the maximum matching score position, each snapshot image has the partial area exhibiting the maximum matching score with respect to an image other than the above snapshot image set. The template matching processing will now be described in greater detail.

In step S001, counter variable “k” is initialized to 1. In step S002, a partial area is defined by adding total sum Pk of average values Vk,k+1 of area movement vectors to the coordinates based on the upper left corner of the image of snapshot image data A corresponding to snapshot image Ak, and the image data of the partial area thus defined is set as the image data of template AQk to be used for template matching. Pk is defined by the equation (14).

$$Pk = {\sum }_{i = 1}^{i - 1} Vi - 1 , i \qquad ( 14 )$$

In step S003, processing is performed to search for a portion of image having the highest matching score with respect to image data AQk of the template set in step S002, that is, a portion of the image data achieving the best matching. More specifically, it is assumed that image data AQk used as the template has an image density of AQk(x, y) at coordinates (x, y) defined based on the upper left corner of the partial area defined by image data AQk, and image data B has an image density of B(s, t) at coordinates (s, t) defined based on its upper left corner. Also, partial area AQk has a width w and a height h, and each of pixels of images AQk and B has possible maximum density of V0. In this case, matching score Ci(s, t) at coordinates (s, t) of image data B can be calculated based on density differences of respective pixels according to the following equation (15).

$$Ci ( s , t ) = {\sum }_{y = 1}^{h} {\sum }_{x = 1}^{w} ( V0 - \vert AQk ( x , y ) - B ( s + x , t + y ) \vert ) \qquad ( 15 )$$

In the image of image data B, coordinates (s, t) are successively updated and matching score C(s, t) in coordinates (s, t) is calculated. A position having the highest value is considered as the maximum matching score position, the image of the partial area at that position is represented as partial area Mk, and the matching score at that position is represented as maximum matching score Ckmax. In step S004, maximum matching score Ckmax in the image of image data B with respect to partial image represented by image data AQk calculated in step S003 is stored at a prescribed address of memory 102. In step S005, movement vector Vk is calculated in accordance with the following equation (16), and is stored at a prescribed address of memory 102.

As already described, processing is effected based on the partial area represented by image data AQk, and the image of image data B is scanned to determine partial area Mk in position M exhibiting the highest matching score with respect to image data AQk. A vector from position P to position M thus determined is referred to as the “movement vector”. This is because the image data B seems to have moved from image data AQk as a reference, as the finger is placed in various manners on fingerprint sensor 100.
Vk=(Vkx, Vky)=(Mkx−AQkx, Mky−AQky) (16)

In the above equation (16), variables AQkx and AQky are x and y coordinates of the reference position of partial area, which is represented by image data AQk, and are determined by adding sum Pn of average value Vk,k+1 of the area movement vectors to the coordinates defined based on the upper left of the image of snapshot image data AQk. Variables Mkx and Mky are x and y coordinates of the position of maximum matching score Ckmax, which is the result of search of the partial area represented by image data AQk, and correspond, by way of example, to the upper left corner coordinates of partial area Mk located at the position of maximum matching in the image of image data B.

In step S006, it is determined whether counter variable “k” is not larger than a value of variable n representing the partial areas or not. If the value of variable “k” is not larger than value n, the flow proceeds to step S007, and otherwise, the process proceeds to step S008. In step S007, 1 is added to the value of variable “k”. Thereafter, as long as the value of variable “k” is not larger than the value of variable n, steps S002 to S007 are repeated. By repeating these steps, template matching is performed for each partial area AQk to calculate maximum matching score Ckmax of each partial area AQk and movement vector Vk.

Maximum matching score position searching unit 105 stores maximum matching score Ckmax and movement vector Vk, which are calculated successively in connection with every partial area AQk as described above, at prescribed addresses of memory 102, and thereafter transmits the template matching end signal to control unit 108 to end the processing.

Thereafter, control unit 108 transmits a similarity score calculation start signal to similarity score calculating unit 106, and waits for reception of a similarity score calculation end signal. Similarity score calculating unit 106 calculates the similarity score through the process of steps S008 to S020 of FIG. 9, using information such as movement vector Vk and maximum matching score Ckmax of each partial area AQk obtained by the template matching and stored in memory 102.

The similarity score calculating processing is performed in the foregoing template matching processing, and is effected on a set of snapshot images reflecting the reference position, which is calculated by position relationship calculating unit 1045, to search for the maximum matching score position of each of the snapshot images. In the maximum matching score position, each snapshot image has the partial area exhibiting the maximum matching score with respect to an image other than the above snapshot image set. Using the maximum matching score position thus determined, the similarity score calculating processing is performed to determine that each position relationship amount, which represents the position relationship with respect to the maximum score position corresponding to each partial area thus determined, falls within a predetermined threshold range. Thereby, the similarity score is determined. Based on the similarity score thus determined, it is determined whether the snapshot image set matches with another image or not. This processing will now be described in greater detail.

In step S008, similarity score P(AQ, B) is initialized to 0. Here, similarity score P(AQ, B) is a variable storing the degree of similarity between image data AQ and B of one snap shot image. In step S009, index “i” of movement vector Vk used as a reference is initialized to 1. In step S010, similarity score Pk related to movement vector Vk used as the reference is initialized to 0. In step S011, index “j” of movement vector Vj is initialized to 1. In step S012, vector difference “dVkj” between reference movement vector Vk and movement vector Vj is calculated in accordance with the following equation (17).
dVkj=|Vk−Vj|=sqrt((Vkx−Vjx)²+(Vky−Vjy)²) (17)

Here, variables Vkx and Vky represent components in x and y directions of movement vector Vk, respectively, and variables Vjx and Vjy represent components in x and y directions of movement vector Vj, respectively. Variable “sqrt(X)” represents a square root of X.

In step S013, vector difference “dVkj” between movement vectors Vk and Vj is compared with prescribed constant value “ε”, and it is determined whether movement vectors Vk and Vj can be regarded as substantially the same vectors or not. If vector difference “dVkj” is smaller than the constant value “ε”, movement vectors Vk and Vj are regarded as substantially the same, and the flow proceeds to step S014. If the difference is larger than the constant value, the movement vectors cannot be regarded as substantially the same, and the flow proceeds to step S015. In step S014, similarity score Pk is increased in accordance with the following equations (18) to (20).
Pk=Pk+α (18)
α=1 (19)
α=Ckmax (20)

In equation (18), variable “α” is a value for incrementing similarity score Pk. If α is set to 1 as represented by equation (19), similarity score Pk represents the number of partial areas that have the same movement vector as reference movement vector Vk. If α is equal to Cjmax as represented by equation (20), similarity score Pk is equal to the total sum of the maximum matching scores obtained through the template matching of partial areas that have the same movement vectors as the reference movement vector Vk. The value of variable “α” may be reduced depending on the magnitude of vector difference “dVkj”.

In step S015, it is determined whether the value of index “j” is smaller than the value of variable n or not. If the value of index “j” is smaller than the value of variable n, the flow proceeds to step S016. If it is larger, the flow proceeds to step S017. In step S016, the value of index “j” is incremented by 1. By the process from step S010 to S016, similarity score Pk is calculated, using the information of partial areas determined to have the same movement vector as the reference movement vector Vk. In step S017, similarity score Pk using movement vector Vk as a reference is compared with variable P(AQ, B). If similarity score Pk is larger than the largest similarity score (value of variable P(AQ, B)) obtained by that time, the flow proceeds to step S018, and otherwise the flow proceeds to step S019.

In step S018, variable P(AQ, B) is set to a value of similarity score Pk using movement vector Vk as a reference. In steps S017 and S018, if similarity score Pk using movement vector Vk as a reference is larger than the maximum value of the similarity score (value of variable P(AQ, B)) calculated by that time using anther movement vector as a reference, the reference movement vector Vk is considered to be the best reference among movement vectors Vk, which have been represented by index “k”.

In step S019, the value of index “k” of reference movement vector Vk is compared with the value of variable n. If the value of index “k” is smaller than the value of value of variable n, the flow proceeds to step S020, in which value of index “i” is incremented by 1.

By the processing from step S008 to step S020, similarity between image data AQk and B is calculated as the value of variable P(AQ, B). Similarity score calculating unit 106 stores the value of variable P(AQ, B) calculated in the above described manner at a prescribed address of memory 102, and transmits a similarity score calculation end signal to control unit 108 to end the process.

Referring to FIG. 4 again, control unit 108 then transmits a collation determination start signal to collation determining unit 107, and waits for reception of a collation determination end signal. Collation determining unit 107 collates and determines (step T18). Specifically, the similarity score given as a value of variable P(AQ, B) stored in memory 102 is compared with a predetermined collation threshold T. If the result of comparison is P(AQ, B)≧T, it is determined that both the images of image data AQ and B are obtained from the same fingerprint, and a value, e.g., of 1 indicating “matching” is written as result data 110 of collation into a prescribed address of memory 102. Otherwise, the images are determined to be obtained from different fingerprints, and a value, e.g., of 0 indicating “mismatching” is written as result data 110 of collation into a prescribed address of memory 102. Thereafter, a collation determination end signal is transmitted to control unit 108, and the process ends.

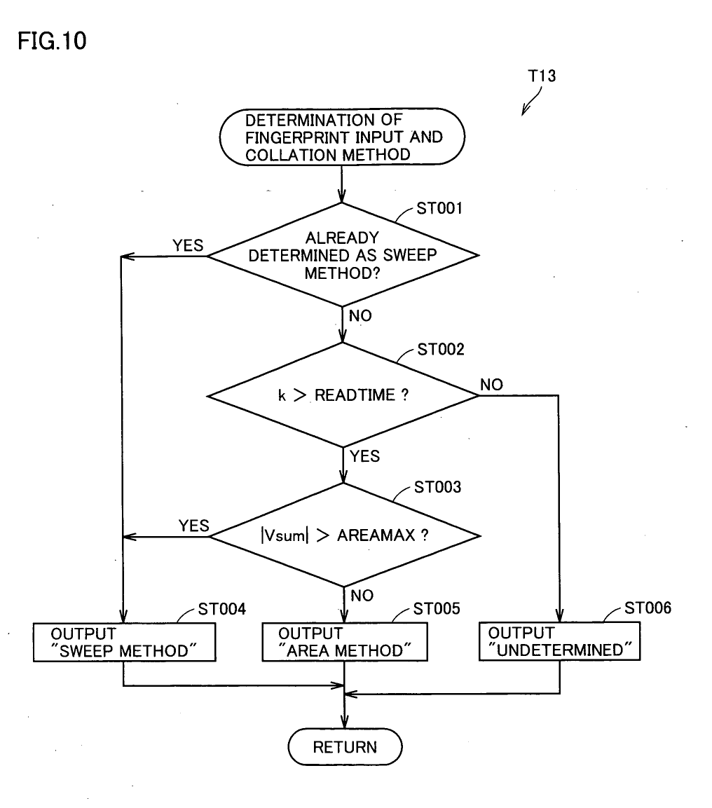

Processing of performing the fingerprint input and collation determination will now be described with reference to a flowchart of FIG. 10.

According to the procedures in FIG. 10, it is determined whether the collation is to be performed in the sweep method or the area method, when the number of loops of the processing from T8 to T15 in FIG. 4 attains a predetermined value.

If the loop from T8 to T15 was already performed one or more times, and it is already determined to use the sweep method in this processing, the sweep method is selected (steps ST001, ST004). Conversely, if the value of variable “k” on memory 102 is smaller than a value of variable READTIME, it is determined that the method is “undetermined” (steps ST002 and ST006). It is determined whether a predetermined time elapsed or not after start of image input to image input unit 1 via sensor 100, and this determination is performed based on whether the number of loops of processing from T8 to T15 reached the value of variable READTIME or not.

In the case other than “undetermined”, reference is made to the value of variable Vsum on memory 102 to calculate |Vsum| indicating a length of variable Vsum. When the calculated value |Vsum| is smaller than a value AREAMAX, the “area method” is selected. Otherwise, the “sweep method” is selected (steps ST003-ST005). The selection result indicating the selected method is stored in memory 102 (or memory 624).

A signal corresponding to the selected method is transmitted to control unit 108 to end the processing of determining the fingerprint input and collation method, and the processing returns to the initial stage in FIG. 4.

Finally, control unit 108 output the collation result stored in memory 102, i.e., selection result data 109 and collation result data 110, via display 610 or printer 690 (step T19), and the image collation ends.

In this embodiment, image correcting unit 104, position relationship calculating unit 1045, maximum matching score position searching unit 105, similarity score calculating unit 106, collation determining unit 107 and control unit 108 may be partially or entirely formed of a ROM such as memory 624 storing programs of the processing procedure and a processor such as a CPU 622 executing the programs.

### Second Embodiment

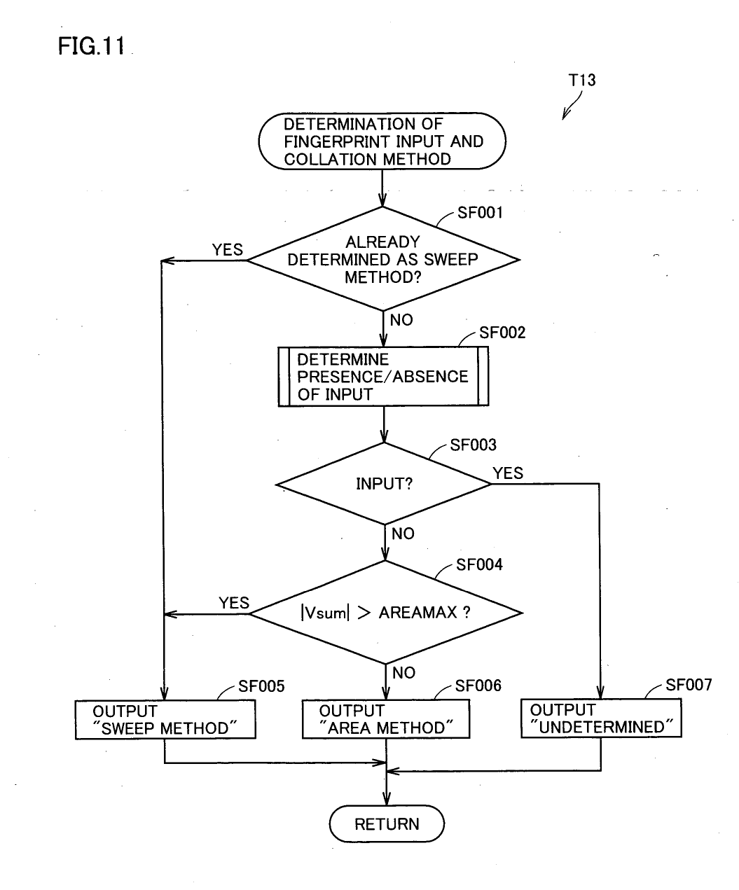

A second embodiment relates to another procedure (step T13) of determining the fingerprint input and collation method in image collating apparatus 1. This procedure will now be described with reference to a flowchart of FIG. 11. In the first embodiment, the determination relating to the sweep method and the area method starts when the number of loops of the processing from T8 to T15 reaches a predetermined value as illustrated in FIG. 10. Instead of this manner, the determination relating to the sweep and area methods may start when a finger is moved away from sensor 100 of image input unit 101, as is done in the second embodiment.

When the loop of the processing of T8-T15 is already performed one or more times, and it is already determined to perform the processing in the sweep method, the “sweep method” is selected (steps SF001 and SF005).

Otherwise, image data Ak+1 is processed similarly to the processing in the flowchart of FIG. 5 (i.e., similarly to the processing in step T3 already described), and input/non-input is determined (step SF002). When the input is present, it is determined that the method is “undetermined” (steps SF003, SF007). When a finger is in contact with sensor 100 of image input unit 101, this state is represented by “the input is present”.

Otherwise, when the finger is removed from sensor 100, the value of vector variable Vsum on memory 102 is determined to calculate the length |Vsum|. When the length “Vsum” is smaller than a predetermined value AREAMAX, the area method is selected. Otherwise, the sweep method is selected (steps SF004-SF006). The result of the determination or selection is stored as selection result data 110 in memory 102 (or 624).

Control unit 108 receives a signal corresponding to the selected method, and ends the processing of determining the fingerprint input and collation method in FIG. 11 so that operation returns to the initial processing in FIG. 4.

### Third Embodiment

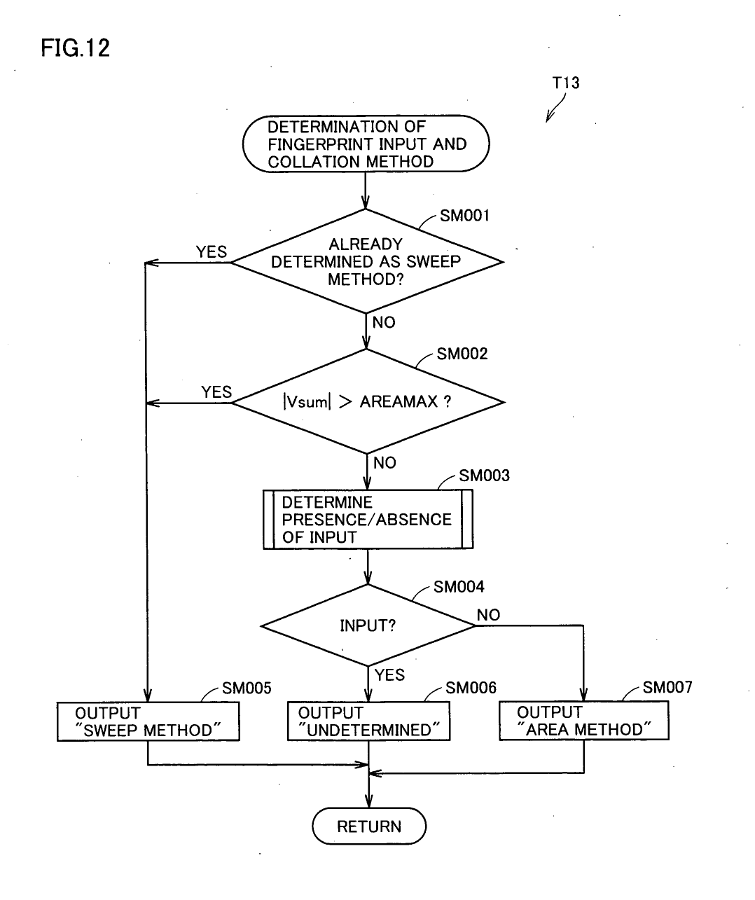

FIG. 12 illustrates a still another processing procedure for the determination of the fingerprint input and the collation method in image collating apparatus 1 of the first embodiment.

In the first embodiment, the sweep method or area method is selected when the number of loops of the processing of T8-T15 reaches a predetermined value. In the second embodiment, the sweep method or area method is selected when the finger is moved away from sensor 100 of image input unit 101. However, another method may be employed, as is done in the third embodiment.

In the third embodiment, when a cumulative movement amount represented by vector variable Vsum reaches a predetermined value while the finger is in contact with sensor 100 of image input unit 101, it is determined the sweep method is to be used. If the cumulative movement amount represented by vector variable Vsum is smaller than the predetermined value when the finger is moved away from sensor 100 of image input unit 101, it is determined the area method is to be used. This procedure will now be described with reference to a flowchart of FIG. 12.

If the loop of processing of T8-T15 was already performed one or more times, and it is already determined to use the sweep method in this processing, the sweep method is selected (steps SM001, SM005).

Otherwise, reference is made to the value of variable Vsum on memory 102 to calculate |Vsum|. When the calculated value is smaller than a certain value AREAMAX (SM002), image data Ak+1 is processed according to the manner in the flowchart of FIG. 5 (i.e., similarly to the processing in step T3), and it is determined whether input is present or not (step SM003). Otherwise, the “sweep method” is selected (steps SM005).

When the input is present according to the determination in step SM003, it is determined that the method is “undetermined” (step SM006). When the input is present, it is determined that the area method is selected (step SM007). The result of the determination or selection is stored as selection result data 109 in memory 102 (or memory 624).

Control unit 108 receives a signal corresponding to the selected method, and ends the processing of determining the fingerprint input and collation method in FIG. 12 so that the operation returns to the initial processing in FIG. 4.

### Fourth Embodiment

In image collating apparatuses 1 of the first to third embodiments, when the result of collation represents “matching”, CPU 622 activates or starts predetermined application programs of the like stored in advance in memory 102 or 624, fixed disk 626, FD 632 or CD-ROM 642. Different kinds of applications may be selectively executed depending on the collation method (area method or sweep method), or the fingerprints (specific fingers), which exhibited “matching” according to the collation result provided in step T19.

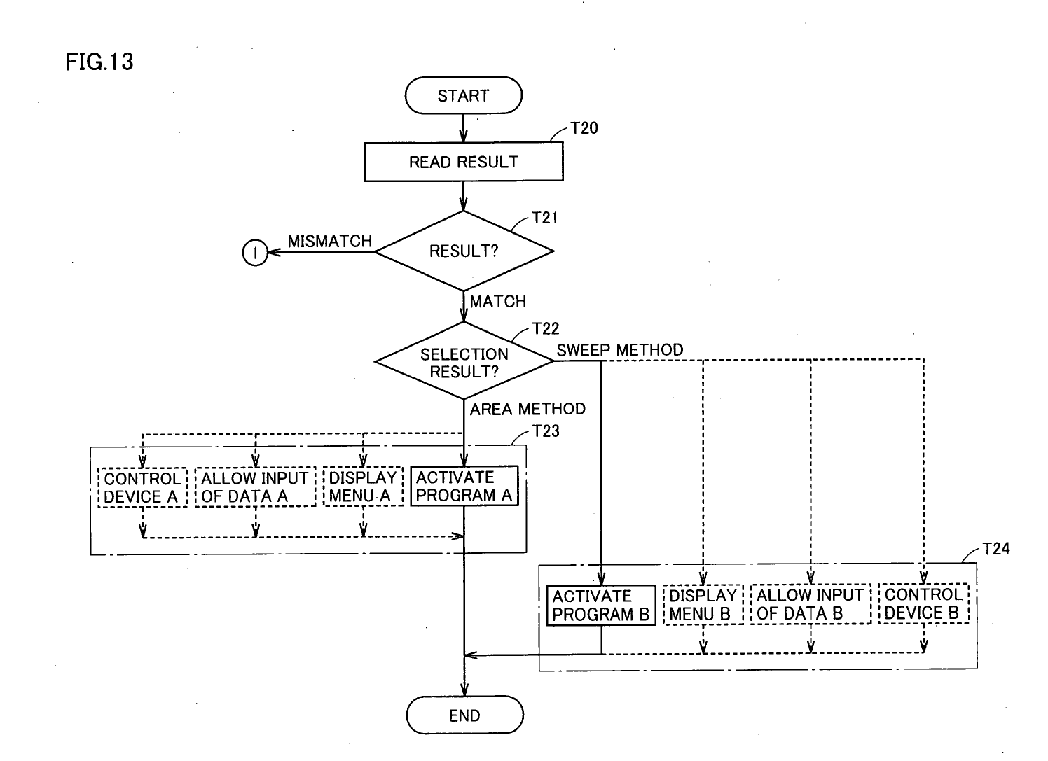

A fourth embodiment will now be described according to a processing flowchart of FIG. 13. First, CPU 622 reads selection result data 109 and collation result data 110 stored in memory 624 (step T20). When CPU 622 determines that collation result data 110 thus read represents “matching” (step T21), processing in and after step T22 will be performed. When CPU 622 determines that collation result data 110 thus read represents “mismatching” (step T21), it ends a series of processing. Before ending the processing, CPU 622 may display a message of “activation is rejected” on display 610.

Then, processing is performed to determine the method instructed by selection result data 109 thus read (step T22). When it is determined that the area method is instructed, a program A is selected from a plurality of programs 647 in memory 626, and is activated or executed. When it is determined that the sweep method is instructed, a program B is selected from, and is activated or executed (steps T23 and T24). Instead of selecting only one program A, two or more programs may be selected.

If image collating apparatus 1 is applied to or employed in a cellular phone, program 647 thus activated is an application program, which changes an operation state of the cellular phone.

The processing in steps T23 and T24 is not restricted to the activation of the above application program, and may be processing represented by broken line in FIG. 13. For example, the processing may be configured such that the cellular phone displays on its display 610 a menu of application programs for changing the operation state when collation result data 110 represents the “matching”. Information in the displayed menu is selected from a plurality of menu data 648 in memory 626 according to the applied collation method (area method or sweep method).

It may be configured to switch the kind of information, which can be entered via keyboard 650. When the collation result represents the “matching”, it may be allowed to provide certain information (e.g., “Yes” or “No”) to the current application program. The information, which can be entered, may be changed depending on the collation method (area method or sweep method).

An object to be activated is not restricted to the application program, and such a manner may be employed that the plurality of target devices 649 are selectively activated via a communication system by remote control, or a certain function of target device 649 may be remotely controlled. For example, target device 649 for illumination may be selected from the plurality of target devices 649, and turn-on/off thereof may be controlled. The kinds of functions to be remotely controlled in selected target devices 649 may be changed depending on the method (area method or sweep method) represented by selection result data 109. The control target to be selected is not restricted to only one target device 649, and two or more target devices 649 may be selected.

The application program may be selectively activated and/or the hardware device may be activated based on, e.g., such a result of collation that a second finger exhibited fingerprint matching in the sweep method, or that a third finger exhibited fingerprint matching in the area method.

The application program may be a more specific program or a program related to security. By activating the application program, it may become possible to enable a function, which is usually disabled, such as a function of telephone, or it may become possible to change a current state of the target device to another state (e.g. state of displaying a list of e-mails), in response to a result of fingerprint collation. Also, data input (e.g., input of character data) may be effected on an application program, which is being executed. Further, an application program, which is being executed, may be forcedly terminated, and another application program (e.g., program of a game corresponding to a collated finger) may be activated.

The application program may be configured to refer several times to a result of collation processing (selection result data 109 or collation result data 1 10) of image collation processing device, and to control the execution of the application program based on each collation result obtained by each referring operation. For example, it is now assumed that the control is effected on execution of an application program related to electronic commerce. First, the result of collation processing is referred to for activating this application program, and the result of the collation is also referred to when personal identification is to be authenticated for determining the control procedure in the application program under execution. Even in this case where the collation must be performed multiple times, the required collation can be executed by only one operation according to the image collation processing performed in the procedure in FIG. 4.

The collation processing for activating an application program or a device does not generally require a high accuracy, but the collation processing for personal identification must be performed with a high accuracy. Therefore, for completing the above collation processing by one operation, it is desired to employ the sweep method, which can achieve the collation with high accuracy.

### Fifth Embodiment

According to the above embodiment, the activation or control of the application program or device to be controlled can be performed based on collation result data 110 or selection result data 109 relating to the sensing method. The sensing method is selected depending on the time-varying relative position relationship between the sensor and the target (fingerprint image) according to the cumulative movement amount based on the movement vectors in FIGS. 10 to 12. However, the sensing method may be selected based on another factor. For example, selection reference data 111 representing the reference for selection of the sensing method may be externally provided to memory 624 (memory 102) via keyboard 650 or the like. Selection reference data 111 may be information, which relates to a purpose of the collation and, e.g., represents whether the collation is to be performed for allowing access to an important system or for allowing turn-on/ff of illumination. Selection reference data 111 may also relate to a degree of importance (a degree of confidentiality) of program 647 or target device 649, of which activation or execution is controlled based on the result of collation. In this case, the processing in step T22 in FIG. 13 is performed by referring to selection reference data 111 instead of selection result data 109.

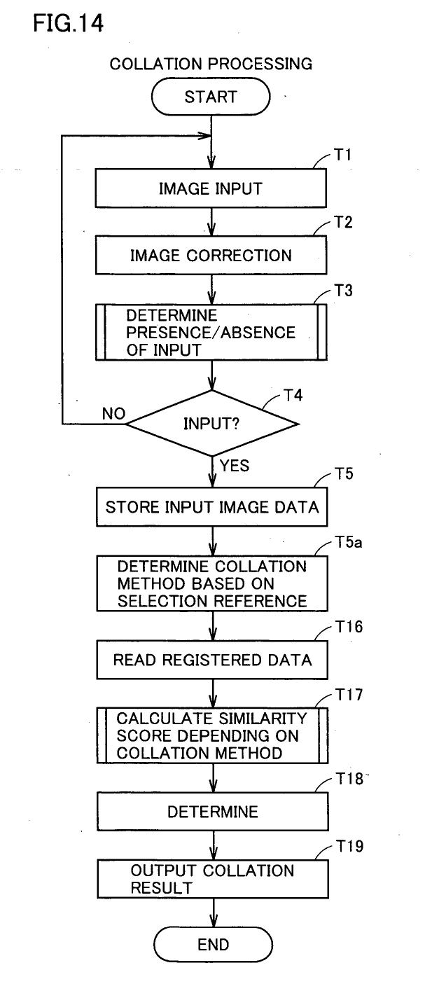

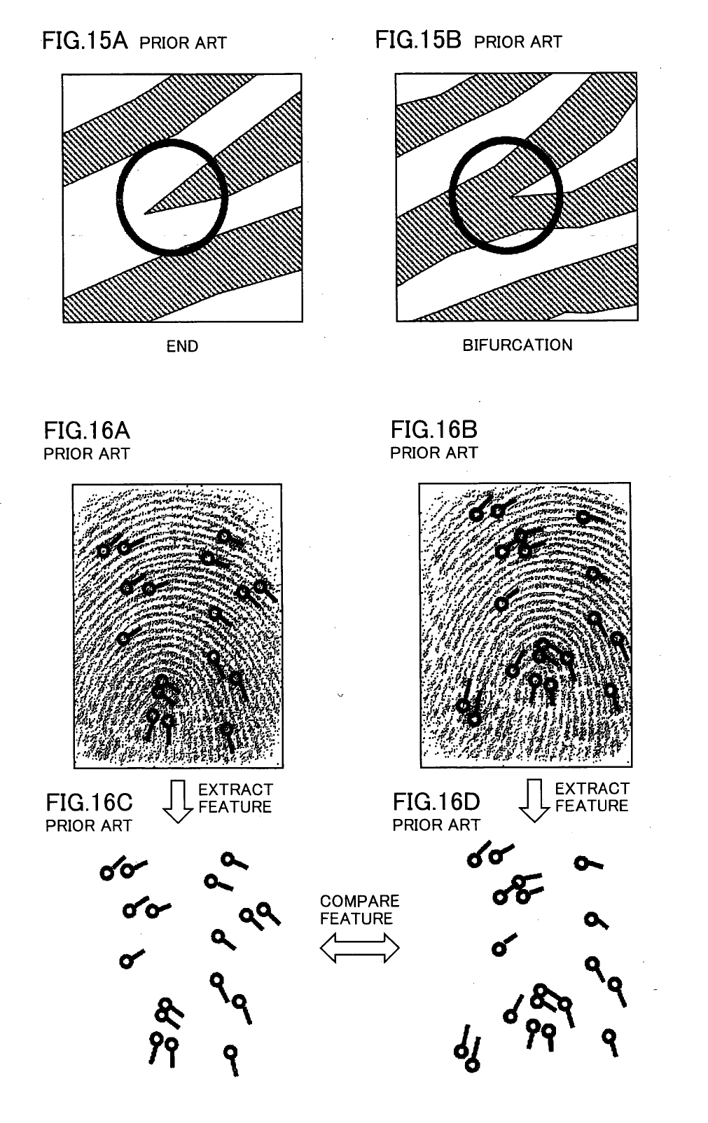

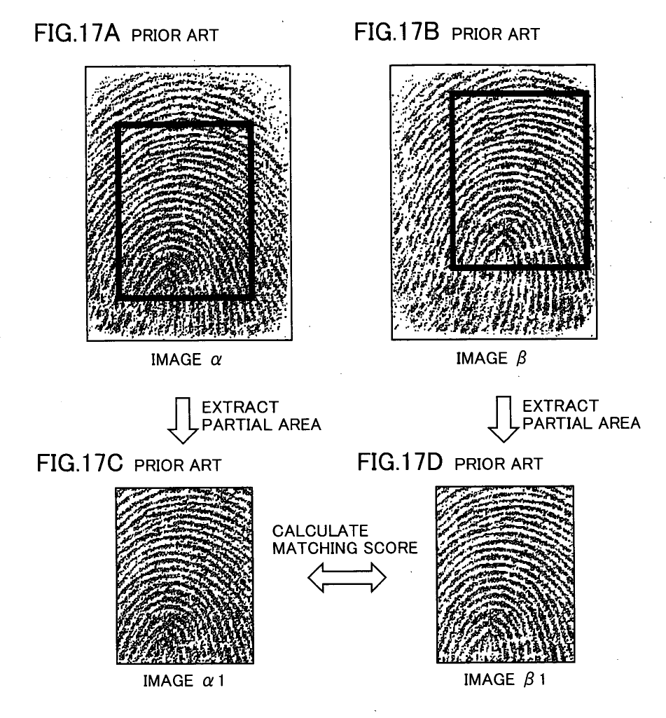

FIG. 14 illustrates a procedure of collation processing performed by referring to selection reference data 111. As can be seen from FIGS. 14 and 4, the selection in the sensing method, which uses the cumulative movement amount based on the movement vectors, and are performed through steps T6-15 in FIG. 4, can be replaced with the determination of the sensing method to be applied based on the result of analysis of selection reference data 111 in step T5a of FIG. 14. Other processing in FIG. 14 is the same as that in FIG. 4.

### Sixth Embodiment

In the embodiments already described, the processing function for image collation as well as the function of target control according to the collation result are achieved by programs. According to a sixth embodiment, such programs are stored on computer-readable recording medium.

In the sixth embodiment, the recording medium may be a memory required for processing by the computer show in FIG. 2 and, for example, may be a program medium itself such as memory 624. Also, the recording medium may be configured to be removably attached to an external storage device of the computer and to allow reading of the recorded program via the external storage device. The external storage device may be a magnetic tape device (not shown), FD drive 630 or CD-ROM drive 640. The recording medium may be a magnetic tape (not shown), FD 632 or CD-ROM 642. In any case, the program recorded on each recording medium may be configured such that CPU 622 accesses the program for execution, or may be configured as follows. The program is read from the recording medium, and is loaded onto a predetermined program storage area in FIG. 2 such as a program storage area of memory 624. The program thus loaded is read by CPU 624 for execution. The program for such loading is prestored in the computer.

The above recording medium can be separated from the computer body. A medium stationarily bearing the program may be used as such recording medium.

More specifically, it is possible to employ tape mediums such as a magnetic tape and a cassette tape as well as disk mediums including magnetic disks such as FD 632 and fixed disk 626, and optical disks such as CD-ROM 642, MO (Magnetic Optical) disk, MD (Mini Disk) and DVD (Digital Versatile Disk), card mediums such as an IC card (including a memory card) and optical card, and semiconductor memories such as a mask ROM, EPROM (Erasable and Programmable ROM), EEPROM (Electrically EPROM) and flash ROM.

Since the computer in FIG. 2 has a structure, which can establish communication over communication network 300 including the Internet. Therefore, the recording medium may be configured to bear flexibly a program downloaded over communication network 300. For downloading the program over communication network 300, a program for download operation may be prestored in the computer itself, or may be preinstalled on the computer itself from another recording medium.

The form of the contents stored on the recording medium is not restricted to the program, and may be data.

Although the present invention has been described and illustrated in detail, it is clearly understood that the same is by way of illustration and example only and is not to be taken by way of limitation, the spirit and scope of the present invention being limited only by the terms of the appended claims.

1. An image collating apparatus comprising:
image input means including a sensor, and allowing input of an image of a target via said sensor in any one of a position-fixed manner fixing a relative positions of said sensor and said target, and a position-changing manner changing the relative positions of said sensor and said target;
position-fixed collating means for collating the image obtained by said image input means in said position-fixed manner with a reference image;
position-changing collating means for collating the image obtained by said image input means in the position-changing manner with said reference image;
determining means for determining, based on a time-varying change in the relative position relationship between said sensor and said target during input of the image of said target by said image input means, whether the image obtained by said image input means is to be collated by said position-fixed collating means or said position-changing collating means; and
selecting means selectively enabling one of said position-fixed collating means and said position-changing collating means according to a result of determination by said determining means.

2. The image collating apparatus according to claim 1, wherein
said determining means determines whether the image obtained by said image input means is to be collated by said position-fixed collating means or said position-changing collating means, depending on whether an amount of change in said relative position relationship reaches a predetermined value or not after elapsing of a predetermined time from start of the input of the image by said image input means.

3. The image collating apparatus according to claim 1, wherein
said determining means includes input determining means for determining whether the image is input by said image input means or not, and
when said input determining means determines that the image is not input, said determining means determines whether the image obtained by said image input means is to be collated by said position-fixed collating means or said position-changing collating means, depending on whether an amount of change in said relative position relationship reaches a predetermined value or not.

4. The image collating apparatus according to claim 1, wherein
said determining means includes input determining means for determining whether the image is input by said image input means or not,
when said input determining means determines that the image is input, and an amount of change in the relative position relationship reaches a predetermined amount, said determining means determines that the image obtained by said image input means is to be collated by said position-changing collating means, and
when said input determining means determines that the image is not input, and said amount of change in the relative position relationship does not reach the predetermined amount, said determining means determines that the image obtained by said image input means is to be collated by said position-fixed collating means.

5. The image collating apparatus according to claim 1, wherein
the control target corresponding to a result of the selection by said selecting means is controlled among said plurality of control targets.

6. The image collating apparatus according to claim 1, wherein
said predetermined control target is controlled based on a result of the collation by one of said position-fixed collating means and said position-changing collating means selectively enabled by said selecting means.

7. The image collating apparatus according to claim 6, wherein
reference is made to said result of collation for at least the purposes of activating said control target and determining the procedure of controlling said control target.

8. An image collating apparatus comprising:
image input means including a sensor, and allowing input of an image of a target via said sensor in any one of a position-fixed manner fixing a relative positions of said sensor and said target, and a position-changing manner changing the relative positions of said sensor and said target;
position-fixed collating means for collating the image obtained by said image input means in said position-fixed manner with a reference image;
position-changing collating means for collating the image obtained by said image input means in the position-changing manner with said reference image;
determining means for determining, based on given predetermined information, whether the image obtained by said image input means is to be collated by said position-fixed collating means or said position-changing collating means;
selecting means selectively enabling one of said position-fixed collating means and said position-changing collating means according to a result of determination by said determining means; and
means for controlling a predetermined control target corresponding to a result of the selection by said selecting means among a plurality of control targets.

9. The image collating apparatus according to claim 8, wherein
said predetermined control target is controlled based on a result of the collation by one of said position-fixed collating means and said position-changing collating means selectively enabled by said selecting means.

10. The image collating apparatus according to claim 9, wherein
reference is made to said result of collation for at least the purposes of activating said predetermined control target and determining the procedure of controlling said control target.

11. The image collating apparatus according to claim 8, wherein
said predetermined information represents a time-varying change in the relative position relationship between said sensor and said target during input of the image of said target by said image input means.

12. The image collating apparatus according to claim 8, wherein
said predetermined information is set variable.

13. The image collating apparatus according to claim 12, wherein
said predetermined information represents a purpose of the collation of the image obtained by said image input means with said reference image.

14. The image collating apparatus according to claim 12, wherein
said predetermined information represents a confidentiality level.

15. An image collating method comprising:
an image input step capable of inputting an image of a target via a sensor prepared in advance in either of a position-fixed manner of fixing said sensor prepared in advance in a position relative to said target or a position-changing manner of changing relative positions of said sensor and said target;
a position-fixed collating step of collating the image obtained according to said position-fixed manner in said image input step with a reference image;
a position-changing collating step of collating the image obtained according to said position-changing manner in said image input step with said reference image;
a determining step of determining whether the image obtained in said image input step is to be collated in said position-fixed collating step or said position-changing collating step based on a time-varying change in a relative position between said sensor and said target during obtaining of the image of said target in said image input step; and
a selecting step of selectively enabling one of said position-fixed collating step and said position-changing collating step according to a result of the determination in said determining step.

16. An image collating program for causing a computer to execute an image collating method, wherein
said image collating method includes:
an image input step capable of inputting an image of a target via a sensor prepared in advance in either of a position-fixed manner of fixing said sensor prepared in advance in a position relative to said target or a position-changing manner of changing relative positions of said sensor and said target;
a position-fixed collating step of collating the image obtained according to said position-fixed manner in said image input step with a reference image;
a position-changing collating step of collating the image obtained according to said position-changing manner in said image input step with said reference image;
a determining step of determining whether the image obtained in said image input step is to be collated in said position-fixed collating step or said position-changing collating step based on a time-varying change in a relative position between said sensor and said target during obtaining of the image of said target in said image input step; and
a selecting step of selectively enabling one of said position-fixed collating step and said position-changing collating step according to a result of the determination in said determining step.

17. A computer-readable recording medium recording an image collating program for causing a computer to execute an image collating method, wherein
said image collating method includes:
an image input step capable of inputting an image of a target via a sensor prepared in advance in either of a position-fixed manner of fixing said sensor prepared in advance in a position relative to said target or a position changing manner of changing relative positions of said sensor and said target;
a position-fixed collating step of collating the image obtained according to said position-fixed manner in said image input step with a reference image;
a position-changing collating step of collating the image obtained according to said position-changing manner in said image input step with said reference image;
a determining step of determining whether the image obtained in said image input step is to be collated in said position-fixed collating step or said position-changing collating step based on a time-varying change in a relative position between said sensor and said target during obtaining of the image of said target in said image input step; and
a selecting step of selectively enabling one of said position-fixed collating step and said position-changing collating step according to a result of the determination in said determining step.

18. An image collating method comprising:
an image input step capable of inputting an image of a target via a sensor prepared in advance in either of a position-fixed manner of fixing said sensor prepared in advance in a position relative to said target or a position-changing manner of changing relative positions of said sensor and said target;
a position-fixed collating step of collating the image obtained according to said position-fixed manner in said image input step with a reference image;
a position-changing collating step of collating the image obtained according to said position-changing manner in said image input step with said reference image;
a determining step of determining, based on given predetermined information, whether the image obtained in said image input step is to be collated in said position-fixed collating step or said position-changing collating step;
a selecting step of selectively enabling one of said position-fixed collating step and said position-changing collating step according to a result of the determination in said determining step; and
a step of controlling a predetermined control target corresponding to a result of the selection in said selecting step among a plurality of control targets.

19. An image collating program for causing a computer to execute an image collating method, wherein
said image collating method includes:
an image input step capable of inputting an image of a target via a sensor prepared in advance in either of a position-fixed manner of fixing said sensor prepared in advance in a position relative to said target or a position-changing manner of changing relative positions of said sensor and said target;
a position-fixed collating step of collating the image obtained according to said position-fixed manner in said image input step with a reference image;
a position-changing collating step of collating the image obtained according to said position-changing manner in said image input step with said reference image;
a determining step of determining, based on given predetermined information, whether the image obtained in said image input step is to be collated in said position-fixed collating step or said position-changing collating step;
a selecting step of selectively enabling one of said position-fixed collating step and said position-changing collating step according to a result of the determination in said determining step; and
a step of controlling a predetermined control target corresponding to a result of the selection in said selecting step among a plurality of control targets.

20. A computer-readable recording medium recording an image collating program for causing a computer to execute an image collating method, wherein
said image collating method includes:
an image input step capable of inputting an image of a target via a sensor prepared in advance in either of a position-fixed manner of fixing said sensor prepared in advance in a position relative to said target or a position-changing manner of changing relative positions of said sensor and said target;
a position-fixed collating step of collating the image obtained according to said position-fixed manner in said image input step with a reference image;
a position-changing collating step of collating the image obtained according to said position-changing manner in said image input step with said reference image;
a determining step of determining, based on given predetermined information, whether the image obtained in said image input step is to be collated in said position-fixed collating step or said position-changing collating step;
a selecting step of selectively enabling-one of said position-fixed collating step and said position-changing collating step according to a result of the determination in said determining step; and
a step of controlling a predetermined control target corresponding to a result of the selection in said selecting step among a plurality of control targets.
